(19) United States
(12) Patent Application Publication
(10) Pub. No.: US 2024/0343267 A1
(43) Pub. Date: Oct. 17, 2024

(54) SYSTEMS AND METHODS FOR CONTEXT BASED KNOWLEDGE FORWARDING IN VEHICULAR KNOWLEDGE NETWORKING

(71) Applicant: TOYOTA MOTOR ENGINEERING & MANUFACTURING NORTH AMERICA, INC., Plano, TX (US)

(72) Inventors: SEYHAN UCAR, Mountain View, CA (US); TAKAMASA HIGUCHI, Mountain View, CA (US); ONUR ALTINTAS, Mountain View, CA (US)

(73) Assignees: TOYOTA MOTOR ENGINEERING & MANUFACTURING NORTH AMERICA, INC., Plano, TX (US); TOYOTA JIDOSHA KABUSHIKI KAISHA, Toyota-shi (JP)

(21) Appl. No.: 18/300,367

(22) Filed: Apr. 13, 2023

(51) Int. Cl. B60W 60/00

(52) U.S. Cl. CPC B60W 60/0015; B60W 30/095; B60W 30/18163; B60W 2554/20; B60W 2554/4029; B60W 2554/408; B60W 2556/45

(57) ABSTRACT

Systems and methods are provided for providing context-based knowledge forwarding which ties a contextual meaning to knowledge, ensuring that knowledge is received within the proper context. A vehicle can query knowledge within a context (e.g., rainy weather conditions), and in response will be forwarded knowledge that was created in similar context (e.g., rainy weather). Contextual features are assigned to knowledge during a knowledge cycle, and contextual features are leveraged when the knowledge is forwarded to be utilized by entities in the vehicular knowledge network. A computer system can construct a knowledge context that corresponds to knowledge. The computer system can also perform context-based knowledge forwarding for a knowledge query by determining that the knowledge context corresponds to a query context of a knowledge query. Consequently, by forwarding knowledge in the correct context, the knowledge is increasingly accurate and beneficial within the vehicular knowledge network, thereby realizing improved vehicle/driver safety features.

### REFERENCE TO RELATED APPLICATIONS

The present application is related to U.S. patent application Ser. No. 16/365,092, filed Mar. 26, 2019, and titled “VEHICULAR KNOWLEDGE DISTRIBUTION SYSTEM”, U.S. patent application Ser. No. 16/735,612, filed Jan. 6, 2020, and titled “VEHICULAR MICRO CLOUD HUBS,” and U.S. patent application Ser. No. 18/173,524, filed Feb. 23, 2023, and titled “SYSTEMS AND METHODS TO IMPROVE KNOWLEDGE CYCLES IN VEHICULAR KNOWLEDGE NETWORKING,” which are incorporated herein by reference in entirety.

### TECHNICAL FIELD

The present disclosure relates generally to systems and methods for vehicular knowledge networking. Specifically, some implementations relate to forwarding knowledge in vehicle knowledge networking based on context.

### DESCRIPTION OF RELATED ART

Technological advancements in the realm of communication networking have led to an emergence of “vehicular networking” (or connected vehicles), where direct connections between vehicles and other points (e.g., infrastructure, network, cloud, etc.) are enabled. With the various types of vehicle communication capabilities that have become available, vehicular networking may be further leveraged to support the concept of sharing “knowledge” in a manner that improves the operation of vehicles.

Occasionally, driving scenarios exist where driver's do not know how to behave. For example, a driver may not understand how to safely perform a merge maneuver with a plurality of vehicles all traveling uniformly in the same lane. A driver may also not know how to proceed through an atypical intersection. Not knowing how to behave in these scenarios can result in accidents. In instances such as these, equipping vehicles with the capability to analyze, store, and share knowledge (e.g., knowledge of how to maneuver safely in certain situations) is promising and can improve vehicle safety and overall performance.

### BRIEF SUMMARY OF THE DISCLOSURE

In accordance with some embodiments, a computer system for constructing and utilizing construct knowledge contextual feature maps corresponding to knowledge in a vehicular network is described. The knowledge context and the knowledge are associated with a first driving environment during creation of the knowledge. Context-based knowledge forwarding can be performed for a knowledge query by determining that the knowledge context corresponds to a query context of a knowledge query. A vehicle communicatively connected to the computer system can generate a query context corresponding to a knowledge query. The query context is associated with a second driving environment during querying for the knowledge. The vehicle submits the knowledge query with the query context. The vehicle comprises a controller that receives the knowledge, in response to the knowledge query, and performs one or more safety operations approaching the second driving environment. The received knowledge is routed to the vehicle using the context-based knowledge forwarding and the received knowledge has a knowledge context that corresponds to the query context of the second driving environment.

In accordance with some embodiments, a system is implemented including at least one memory storing machine-executable instructions and at least one processor configured to access the at least one memory and execute the machine-executable instructions to construct knowledge contextual feature maps corresponding to knowledge is described. The knowledge contextual feature maps and the knowledge are associated with a first driving environment during creating the knowledge. The knowledge query is received with query contextual feature maps corresponding to the query. The query contextual feature maps and the knowledge query are associated with a second driving environment during querying the knowledge. A context-based routing is performed for the knowledge query, which is based on performing a context analysis function on the knowledge feature maps and the query feature maps. The knowledge is retrieved and forwarded in a via a vehicular knowledge network, and in response to determining a contextual relationship between the knowledge feature maps and the query feature maps based on the performed context analysis function.

In accordance with some embodiments, a method is implemented that includes constructing knowledge contextual feature maps corresponding to knowledge. The knowledge contextual feature maps and the knowledge are associated with a first driving environment during creating the knowledge. A knowledge query with query contextual feature maps corresponding to the query are received, where the query contextual feature maps and the knowledge query are associated with a second driving environment during querying the knowledge. A context-based routing for the knowledge query is performed based on performing a context analysis function on the knowledge feature maps and the query feature maps. The knowledge is retrieved and forwarded in a vehicular knowledge network in response to determining a contextual relationship between the knowledge feature maps and the query feature maps based on the performed context analysis function.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 depicts an example illustration of a vehicle environment implementing a vehicular knowledge networking system including context-based knowledge forwarding, according to one embodiment.

FIG. 2 depicts a conceptual diagram for a hierarchal architecture for data, information, and knowledge used in a vehicular knowledge network, for example the vehicular knowledge network of FIG. 1, according to one embodiment.

FIG. 3 depicts an example vehicle in which the systems and methods disclosed herein may be applied.

FIG. 4 depicts an example network architecture of an in-vehicle vehicular knowledge networking system, for example the vehicular knowledge network shown in FIG. 1, according to one embodiment.

FIG. 5 depicts an example network architecture of a remote vehicular knowledge networking system, for example the vehicular knowledge networking system of FIG. 1, according to one embodiment.

FIG. 6 depicts an example of a method of implementing context-based knowledge forwarding, according to one embodiment.

FIG. 7 depicts another example illustration of a vehicle environment implementing a vehicular knowledge networking system including context-based knowledge forwarding, according to one embodiment.

FIG. 8 depicts a conceptual diagram of implementing a knowledge cycle based on context-based analysis of knowledge, according to one embodiment.

FIG. 9 is an example computing component that may be used to implement various features of embodiments described in the present disclosure.

The figures are not exhaustive and do not limit the present disclosure to the precise form disclosed.

### DETAILED DESCRIPTION

On occasion, in certain complicated driving environments that may be confusing to the driver, a driver may not know how to behave or may behave in a manner that is risky and increases the potential of a dangerous accident (or collision). A driver's behavior can refer generally to actions, reactions, or operations, that may be performed or undertaken by a driver while operating a vehicle. At certain times while operating a vehicle, traffic conditions, environmental conditions, or the vehicle's condition and/or operating state may cause or result in a driver not knowing or understanding what action, reaction, or driving decision, should be performed upon encountering such a condition. For example, when a driver enters into a roundabout, or when a driver is attempting to merge into a lane with a platoon of vehicles (i.e., a series of vehicles traveling at roughly the same speed in the same lane at roughly the same intervals), the driver may not know the right-of-way rules associated with the roadway or the traffic pattern. Another such example is when a driver misses their intended exit, and as a result may be confused as to whether they should refrain from performing any risky driving maneuvers (e.g., keep going and eventually loop back around) which then causes them to have to reroute. However, in this scenario, some drivers decide to engage in risky behavior in attempt to reach the correct exit, such as perform abrupt lane changes or slam on the brakes on the shoulder of the road, hoping they can still make the turn. In order to address the aforementioned and similar issues, equipping vehicles with capabilities to infer and share guidance in instances when many drivers become confused in these complicated driving environments (referred to herein as risky zone) may mitigate collision risk in these zones, thereby preventing vehicular damage, bodily injury and/or fatality, and significantly improving overall driver safety.

Current methods to improve vehicle safety typically include providing feedback as the driver engages in an unsafe driving maneuver. For example, a current driver/vehicle safety system may produce an audible notification to warn the driver that they are attempting to move into a lane that is already occupied by another vehicle. Particularly, a current driver/vehicle safety system may beep if a driver attempts to change lanes and does not see another vehicle in his/her blind spot, in order to notify the driver of the vehicle in his/her blind spot. Although such safety alerts can be helpful, current driver/vehicle safety systems are often restricted to functioning while the driver is in the middle of a dangerous maneuver (e.g., providing little to no reaction time) which increases the risk of a catastrophic collision. In other words, these conventional driver/vehicle safety systems do not proactively provide guidance and/or knowledge that the driver can utilize while they are still approaching a risky zone. Although reactive feedback methods offer some level of prevention, a predictive system and method could prevent the drivers from engaging in the unsafe driving maneuver altogether.

In contrast to the aforementioned conventional systems, the disclosed System distinctly leverages communicating “knowledge” between vehicles (also referred to herein a vehicular knowledge networking) in a manner that proactively warns drivers in risky zones (e.g., risky and/or confusing driving environments). For instance, the disclosed system employs vehicular networking capabilities, such as vehicle-to-vehicle (V2) communication, to create and distribute contextual knowledge of risky zones. This knowledge can be received by a vehicle (e.g., a driver approaching said risky zone) as early, allowing the driver to be preemptively prepared before entering the risky zone and then safely maneuver once driving inside of the zone. Alternatively, with using conventional driver/vehicle safety systems, the driver would not be warned until they are already in the risky zone, confused, and performing risky maneuver that could cause a dangerous crash. Because it is so crucial to stay alert and aware of complicated driving environments, like risky zones, while driving, the disclosed embodiments utilize vehicular knowledge networking to implement a more effective safety system that equips vehicles to provide a priori guidance (e.g., prior to entering the risky zone) in a manner that thwarts driver confusion and enables the driver to be ready for maneuvering safely before reaching the risky zone. Restated, the vehicular knowledge network system and methods proposed herein, leverage knowledge to assist drivers in various driver/vehicle safety applications, such as risk reasoning and vehicular maneuvering in a manner that is preemptive and provides improvements over the reactionary (i.e., systems based on the driver engaging, or attempting to engage in a driving maneuver) limitations of conventional driver/vehicle safety systems.

Furthermore, the disclosed embodiments include a context-based knowledge forwarding process which ties a contextual meaning to knowledge, with the objective of ensuring that knowledge is received within the proper context and ultimately more accurate. As described herein, context is related to circumstances, descriptors, and situational characteristics for an event and/or location (e.g., driving environment) in terms that allow the environment at that time to be fully understood and assessed. With respect to vehicular knowledge networking, a “context” for knowledge can be formed from several characteristics that particularly describe aspects of the driving environment, such as road geometry, traffic flow, and the like, that are linked to a time when the knowledge was initially created. For example, knowledge of a risky zone may be created using the data obtained from vehicles that were experiencing clear weather conditions while in the location. However, it may be detrimental if a vehicle that is currently driving in that same location, but in rainy weather conditions, attempts to apply that knowledge (having a “clear weather” context) for its risky zone analysis. If knowledge is utilized in the wrong context, even when it is the “correct” knowledge (e.g., knowledge for the right location and/or event), the knowledge's accuracy may be undermined in a manner that negatively affects the vehicle's functions, for instance leading to the vehicle making incorrect risky zone decisions or faulty actions/maneuvers, which impacts the overall driver/vehicle safety. In other words, the accuracy and usefulness of knowledge can be substantively weakened when the knowledge is retrieved in a context that is dissimilar to the context in which it was created.

Thus, context-based knowledge forwarding, as disclosed herein, ensures that the proper knowledge is also retrieved in the proper context. For example, in accordance with context-based knowledge forwarding, a vehicle that queries knowledge within the context of traveling in rainy weather conditions, particularly receives knowledge that was created in a similar rainy weather context. The disclosed embodiments include a distinct process that assigns various contextual features to knowledge during a knowledge cycle, particularly while the knowledge is created (e.g., forming a contextual frame for knowledge), and later leverages these contextual features when the knowledge is forwarded to be utilized by entities in the vehicular knowledge network. A knowledge cycle, as described herein, includes several interrelated stages that involve dissemination and utilization of knowledge, including: knowledge creation; knowledge storing; knowledge networking; and knowledge refining (e.g., knowledge transfer and knowledge composition). The aforementioned knowledge cycle, the entities involved in the communication (e.g., vehicles, infrastructure, etc.), the vehicular network (e.g., vehicle-to-vehicle networking, vehicle-to-cloud networking, etc.), data (e.g., knowledge), and functionality related to creating and using knowledge can be referred to collectively as “vehicular knowledge networking.” Consequently, by making certain that knowledge is used in the correct context, the disclosed embodiments ensure that knowledge is increasingly accurate and beneficial within the vehicular knowledge network, thereby realizing improved vehicle/driver safety features.

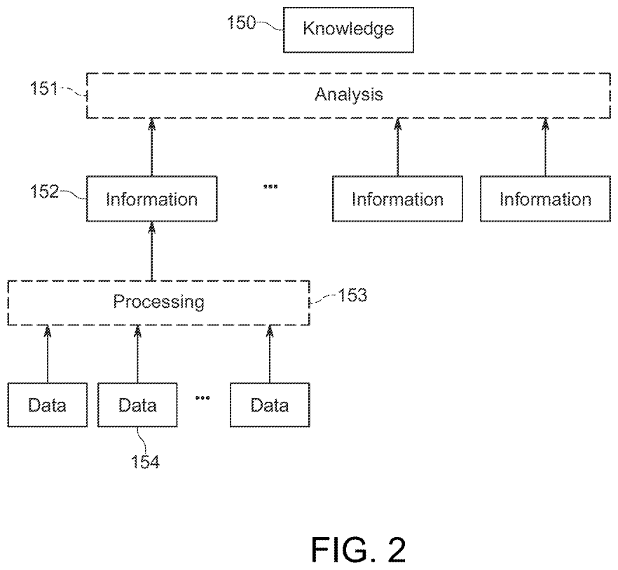

A referred to herein, “knowledge” is conceptually a state of understanding that is obtained through experience and analysis of collected information, such as raw data. A critical function of the vehicular knowledge network, as disclosed herein, is the capability to transform data, such as raw data collected from vehicle sensors, into searchable knowledge, and subsequently to create and distribute this knowledge with various life cycles and relevance. Referring now to FIG. 2, a conceptual diagram depicts a hierarchy among data 254, information 252, and knowledge 250. As seen in FIG. 2, the hierarchy can include data 254 which is a piece of a recorded experience, such as vehicular speed mph, time t, position p that may be collected as raw data from the vehicle's sensors. In addition, the hierarchy can include information 252 which is pieces of data 254 that have been subjected to processing 253. Thus, data 254 can be contextual “meaningful.” For instance, continuing with the example, the aforementioned raw data 254 from the vehicle can be processed to ascertain meaningful information 252 about the vehicle, such as “the vehicle was moving at a speed mph at time t and at position p.” Further, FIG. 2 illustrates that information 252 can be subjected to analysis 251 in order to derive knowledge 250. It is knowledge 250 that is the most contextual-rich in comparison to data 254 and information 252, which is as illustrated by knowledge 250 being at the top of the hierarchy. As alluded to above, knowledge 250 can be considered as a fact, a belief extracted by analyzing patterns in information 252. For instance, knowledge 250 can be created through analysis 151 of multiple instances of information 252 and it is a fact or a belief that represents the hidden relationship among the information 252. Again, continuing with the example, knowledge 250 can be inferred insight surrounding the vehicle, where knowledge 250 identifies that sequential conflicts happen the most in an area X (related to vehicle's location P), thus X is a risky zone. The creation of knowledge 250 may require computationally hungry algorithms and a set of information 252 and/or data 254 that are potentially from multiple sources (e.g., vehicles). In operation, the vehicular knowledge network depicted in FIG. 2 organizes vehicle sensor measurements into data 254, information 252, and knowledge 250. Moreover, contextual data (also referred to herein as contextual features) for knowledge define a degree of similarity in data 254, information 252 and knowledge 250. For instance, types of data 254 that describe various situational conditions that the vehicle is traveling in at a location, such as road geometry, traffic flow/congestion, weather conditions, and the like, can be collected to form a contextual frame around that location, and ultimately a context for the knowledge 150 for that location. Restated, the disclosed embodiments use certain data 154 as contextual features that link a contextual relevance, namely a context, to the corresponding knowledge 150. Further, the contextual features can be analyzed to determine whether knowledge 150 is in the right context (e.g., having similar contextual features) for a specific vehicle query.

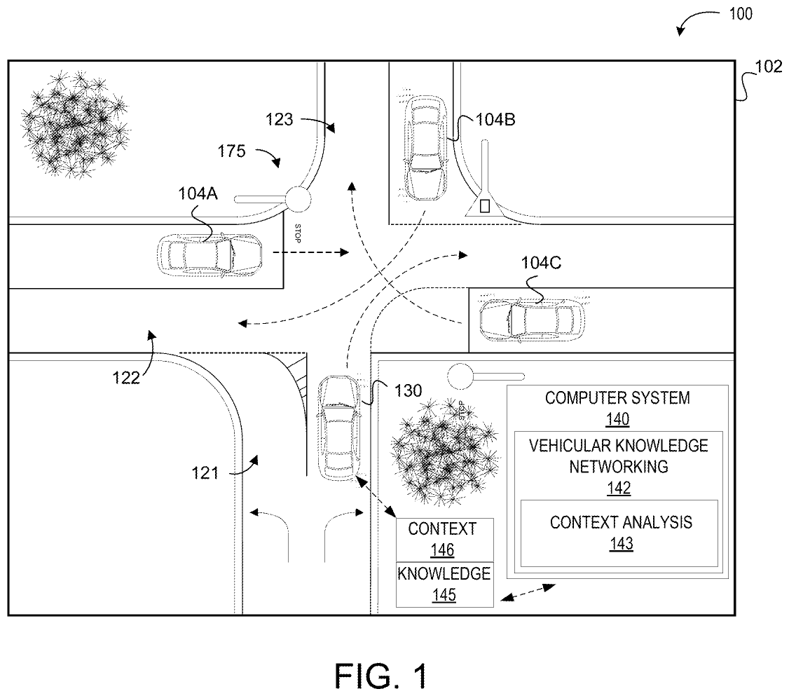

FIG. 1 is a schematic diagram of an example environment 102 in which a vehicular knowledge network system 100 can be implemented. The example operating environment 102 includes an ego vehicle 130, and one or more vehicles 104A-104C at a complicated driving environment shown as an atypical four-way intersection. The atypical intersection is an any intersection that includes roadway features that may cause driver confusion, and thus may be considered as a risky zone. The roadway features can be any type of traffic signals, roadway patterns, roadway hazards etc. that may cause a driver to become confused as to how to proceed through the intersection. For example, in one embodiment, the atypical intersection can include the intersection of FIG. 1. It should be understood that the operational environment in FIG. 1 is described for purposes of illustration and is not intended to be limiting, thus the described vehicular knowledge networking and context-based knowledge forwarding capabilities can implement enhanced driver/vehicle safety functions that are similarly applicable to various other types of potentially risky, confusing, or dangerous driving environments that are not shown (e.g., roundabouts, exits, and the like). Thus, in another example, the atypical intersection can include an intersection with no-electricity (a traffic signal outage). The atypical four-way intersection of FIG. 1 includes a first roadway 121, a second roadway 122 and a third roadway 123. The first roadway 121 and the third roadway 123 intersect the second roadway 122 at different points, creating an offset intersection 175.

The vehicular knowledge networking and context-based knowledge forwarding capabilities, as disclosed herein, may be implemented with any of a number of different vehicles and vehicle types. For example, the systems and methods disclosed herein may be used with automobiles, trucks, motorcycles, recreational vehicles and other like on-or off-road vehicles. In addition, the principals disclosed herein may also extend to other vehicle types as well. In the example of FIG. 1, the vehicle 130 in which embodiments of the disclosed technology may be implemented is illustrated. Although the example described with reference to FIG. 1 is a type of semi-autonomous vehicle, the systems and methods described herein can be implemented in other types of vehicles including autonomous vehicles, vehicles with automatic controls (e.g., dynamic cruise control), or other vehicles. Also, the example vehicle 130 described with reference to FIG. 1A is a type of hybrid electric vehicle (HEV). However, this is not intended to be limiting, and the disclosed embodiments can be implemented in other types of vehicles including gasoline-or diesel-powered vehicles, fuel-cell vehicles, electric vehicles, or other vehicles.

According to an embodiment, vehicle 130 can be a semi-autonomous vehicle, such as a vehicle having assisted driving capabilities, which also implements the vehicular knowledge networking and improved knowledge cycle functions, as disclosed herein. “Semi-autonomous operational mode” means that a portion of the navigation and/or maneuvering of the vehicle 130 along a travel route is performed by one or more computing systems, and a portion of the navigation and/or maneuvering of the vehicle 130 along a travel route is performed by a human driver. One example of a semi-autonomous operational mode is when an adaptive cruise control system is activated. In such case, the speed of a vehicle 130 can be automatically adjusted to maintain a safe distance from a vehicle ahead based on data received from on-board sensors, but the vehicle 130 is otherwise operated manually by a human driver. Upon receiving a driver input to alter the speed of the vehicle (e.g., by depressing the brake pedal to reduce the speed of the vehicle), the speed of the vehicle is reduced. Thus, with vehicle 130 operating as a semi-autonomous vehicle, a response can be partially automated. In an example, the controller communicates a newly generated (or updated) control to the vehicle 130 operating as a semi-autonomous vehicle. The vehicle 130 can automatically perform some of the desired adjustments (e.g., accelerating) with no human driver interaction. Alternatively, the vehicle 130 may notify a driver that driver input is necessary or desired in response to a new (or updated) safety control.

Alternatively, or in addition to the above-described modes, vehicle 130 can have one or more autonomous operational modes. As used herein, “autonomous vehicle” means a vehicle that is configured to operate in an autonomous operational mode. “Autonomous operational mode” means that one or more computing systems of the vehicle 130 are used to navigate and/or maneuver the vehicle along a travel route with a limited level of input from a human driver which varies with the operational mode. As such, vehicle 130 can have a plurality of autonomous operational modes, where each mode correspondingly responds to a controller, with a varied level of automated response. In some embodiments, the vehicle 130 can have an unmonitored autonomous operational mode. “Unmonitored autonomous operational mode” means that one or more computing systems are used to maneuver the vehicle along a travel route fully autonomously, requiring no input or supervision required from a human driver. Thus, as an unmonitored autonomous vehicle 130, responses can be highly, or fully, automated. For example, a controller can be configured to communicate controls so as to operate the vehicle 130 autonomously and safely. After the controller communicates a control to the vehicle 130 operating as an autonomous vehicle, the vehicle 130 can automatically perform the desired adjustments (e.g., accelerating or decelerating) with no human driver interaction. Accordingly, vehicle 130 can operate any of its components autonomously, such as an engine.

The plurality of vehicles depicted in the example environment 102 of FIG. 1 includes the ego vehicle 130 and vehicles 104A-104C. Vehicles 104A-104C may each provide similar functionality to the ego vehicle 130. Ego vehicle 103 may be any type of vehicle. For example, ego vehicle 103 may be a car; a truck; a sports utility vehicle; a bus; a semi-truck; a drone or any other roadway-based conveyance. Also, FIG. 1 depicts the ego vehicle 130 and vehicles 104A-104C as a network of connected vehicles. As used herein, “connected vehicle” refers to a vehicle that is actively connected to edge devices, other vehicles, and/or a cloud server via a network through V2X communication comprising V2I, V2C, C2V and/or V2V communications. For example, the ego vehicle 130 and the vehicles 104A-104C are connected vehicles that include communication circuitry (and other hardware/software providing such capabilities installed thereon) which is capable of wireless communication (e.g., V2X, V2I, V2V, etc.) that enables active connections to other vehicles and/or communication devices. As an example, vehicles 130, 104A-104C communicate with each other using vehicle-to-vehicle (V2V) and communicate to the remote cloud and/or the computer system 140 (or edge server) through the and vehicle-to-cloud (V2C) communication. Accordingly, the ego vehicle 130, vehicles 104A-104C, and the computer system 140 being within the same vicinity can be considered a hub of the vehicular knowledge network system 100. Generally, vehicular knowledge network system 100 supports several key functions, including, but not limited to: executing a knowledge cycle (e.g., including creating knowledge), as disclosed herein; communicating requests to knowledge nodes (e.g., vehicles 130, 104A-104C) for one or more instances of knowledge; forwarding the requests toward appropriate knowledge nodes, which are expected to have the requested knowledge (e.g., nodes closer to the geographical region), based on contextual features; communicating responses to the requests from other knowledge nodes if it has the requested knowledge in its own knowledge base or from edge server; and communicating the requested knowledge to communication points and knowledge nodes within the system 100 based on contextual features. Thus, by implementing aspects of vehicular knowledge networking, the ego vehicle 130 can have its own knowledge base, which can be shared and/or communicated with a remote cloud and/or computer system 140 (e.g., edge server) and other vehicles 104A-104C.

According to the embodiments, the vehicle 130 is distinctly configured to implement the vehicular knowledge networking and context-based knowledge forwarding capabilities, as disclosed herein. That is, the vehicle 130 is equipped to convert data generated and exchanged among vehicles into knowledge 145, where the knowledge 145 provides insight regarding traffic events, driving environment, driving conditions, congestion, and the like. Furthermore, the vehicle 130 can utilize accessed knowledge 145 in order to optimize various vehicular safety applications. Particularly, in the example of FIG. 1, the vehicle 130 can leverage vehicular knowledge networking in order to perform a risk reasoning application. Thus, by implementing risk reasoning, vehicle 130 can quantify the risk levels in their environment and identify the knowledge of risky zones (e.g., risky road users and risky zone locations), and leverage the knowledge of the risky zone to generate guidance for the driver to mitigate risk and improve traffic flow. Risk reasoning can involve analyzing vehicular maneuver conflicts to extract the knowledge of risky road users and risky locations, in manner that improves traffic planning and safe driving. As alluded to above, an example of a risky zone is illustrated in FIG. 1 as an atypical intersection.

In an embodiment, all of the entities in the vehicular knowledge network system 100, namely the ego vehicle 130, vehicles 104A-104C, and computer system 140, are configured to implement various aspects of vehicular knowledge networking, including the disclosed improved knowledge cycle. In one or more embodiments of the present disclosure, functions supporting vehicular knowledge networking and the improved knowledge cycle can be performed as part of a training process, which may be carried out using a computer system 140. In the example of FIG. 1, the computer system 140 is depicted as a server, namely an edge server, within the vehicular knowledge network 100. As seen in FIG. 1, the computer system 140 (also referred to herein as edge server) is configured to include a vehicular knowledge networking system 142 and a context analysis system 143. For example, the computer system 140 might include one or more processors, controllers, control modules, or other processing devices, where the vehicular knowledge network system 142 and the context analysis system 143 are implemented as hardware processor(s). Alternatively, the vehicular knowledge networking system 142 and the context analysis system 143 may be implemented as software on the computer system 140, such as instructions, machine-readable code, or computer program components.

The computer system 140 may be an edge server that resides as a back-end system relative to vehicles 130, and 104A-104C. By way of example, knowledge 145 can be created on the computer system 140, operating as an edge server, via the received data and/or information that is received from connected vehicles. Subsequently, knowledge 145 can be distributed throughout the vehicular knowledge network system 100. FIG. 1 depicts knowledge 145, being created at computer system 140, being distributed through the V2C communications to ego vehicle 130. For instance, once optimization of the knowledge cycle has converged on the computer system 140, knowledge 145 can then be uploaded to a computer system of the ego vehicle 130, for example in the form of trained machine learning models, and used for autonomous, semi-autonomous, assisted, or other driving systems. It should also be appreciated upon studying the present disclosure that in one or more embodiments the functions or elements of computer system 140 (including the vehicular knowledge networking unit 142 and the knowledge cycle unit 143) may reside on board a vehicle, such as ego vehicle 130. For example, all or part of computer system 140 may reside within ego vehicle 130 and their functionalities may be performed thereby.

As previously described, entities of the vehicular knowledge network system 100 are configured to execute the disclosed context-based knowledge forwarding techniques. Accordingly, the computer system 140 can receive contextual features from several vehicles, where the contextual features represent various conditions of a current driving environment. For example, vehicles that have previously traversed the atypical intersection of FIG. 1 leveraged their capabilities (e.g., vehicle sensors) to collect data that was descriptive of the conditions experienced at the time while driving through the intersection, such as traffic flow, vehicle/driver type, congestion, type of objects at the location, risk caused by other drivers and the like. This data, being the contextual features of the atypical intersection, can be received and further analyzed by the computer system 140 (context analysis engine 143) to provide a “context” for the knowledge that will be created about the atypical intersection. That is, the computer system 140 can analyze the contextual features (e.g., generated by a plurality of vehicles) of a location, in order to generate one or more contextual feature maps that infer a context surrounding any knowledge corresponding to the location. According to the embodiments, the context for knowledge (e.g., contextual feature maps) is created concurrently with the knowledge itself, so as to eliminate any additional overhead and/or delays when the knowledge is actually needed (e.g., knowledge forwarded to entities of the vehicular knowledge network). In other words, the context that corresponds to an instance of knowledge is created during its knowledge cycle (e.g., creating the knowledge). The knowledge cycle can be described as the overall steps for creating and/or distributing knowledge in vehicular knowledge networking, such as vehicular knowledge network system 100. Generally, a knowledge cycle implemented that may be implemented by the vehicular knowledge networking system 142 includes several steps, including but not limited to: knowledge creation; knowledge storage, where the created knowledge is stored and placed intelligently such that a high number of vehicles can access and consume it; knowledge networking, which involves developing the network topology and query/distribution of knowledge; knowledge transfer and knowledge composition, which involves refinement of the knowledge such as merge/accumulation of knowledge.

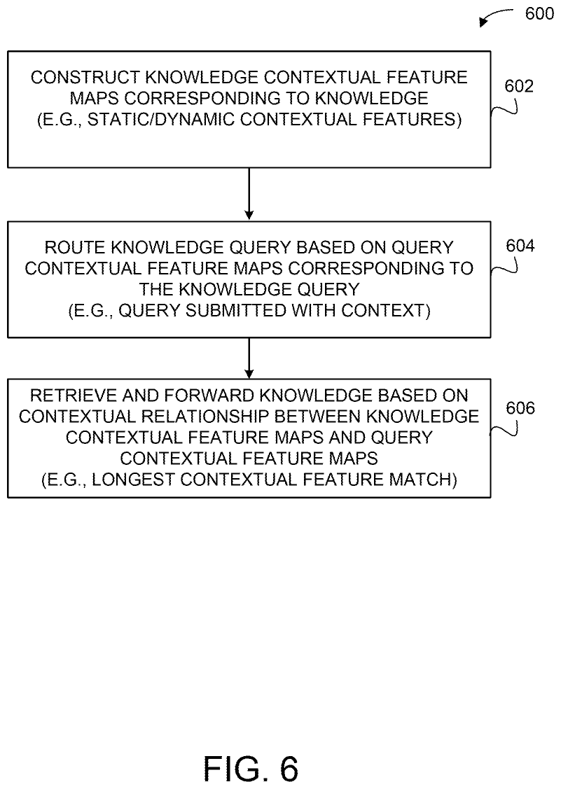

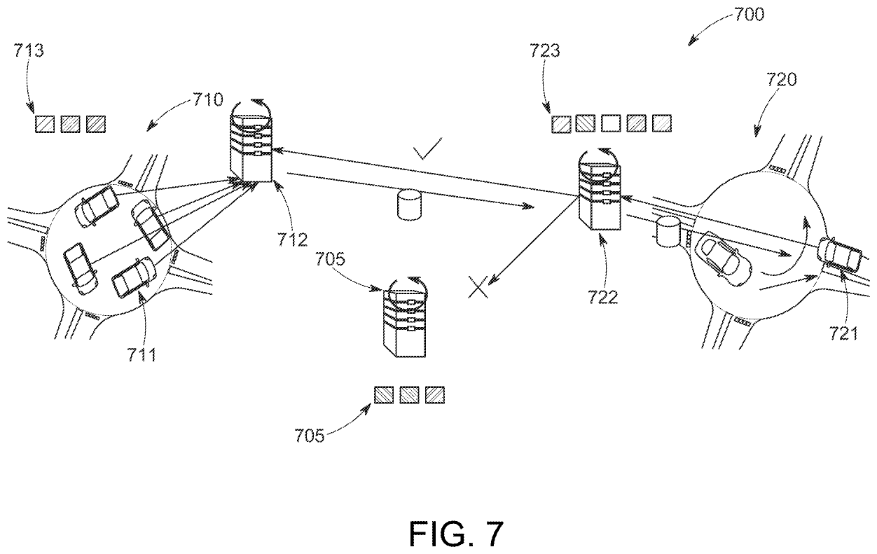

FIG. 1 depicts the computer system 140 as an entity implementing aspects of the context-based forwarding, having context analysis system 143 which is distinctly configured to execute the context-based knowledge forwarding techniques disclosed herein. Details of the context-based knowledge forwarding are described in reference to FIG. 6-FIG. 7. Thus, for purposes of brevity, these details are not described here in the discussion of FIG. 1. In an embodiment, the context analysis system 143 is configured to execute the context-based knowledge forwarding methods depicted in FIG. 6 and FIG. 7.

Generally, the context analysis system 143 is configured to perform distinct “knowledge context” related functions of the disclosed embodiments, including: obtaining contextual features specific to a location before knowledge is created; analyzing the contextual features to create contextual feature maps (inferring the context) specific to a location while its knowledge is created; retrieving the right knowledge without additional delay; and preparing knowledge based on its derived context beforehand to maximize the benefits. A design goal of vehicular knowledge networking is to maximize the benefits of its knowledge (e.g., knowledge is useful/utilized by a large number of entities), thus having insight into the context for knowledge can be used to dynamically make knowledge more beneficial, ensuring that the right knowledge is forwarded to an entity in the right context. Therefore, entities in the vehicular knowledge network 100, such as ego vehicle 130, may leverage potentially “improved” knowledge 145 resulting from an improved knowledge cycle (e.g., optimized by the disclosed improved knowledge cycle techniques). Furthermore, forwarding knowledge based on its context may provide better insight regarding the risky zone (shown as atypical intersection) in a manner that improves guidance for the vehicle through the risky zone thereby improving overall vehicle/driver safety.

FIG. 1 depicts knowledge 145, which is communicated throughout the vehicular knowledge network system 100, and can be created by a single vehicle and/or group of vehicles (e.g., vehicular micro cloud) cooperatively. Thus, the ego vehicle 130 and surrounding vehicles 104A-104C can be referred to as knowledge nodes within the vehicular knowledge network system 100. Alternatively, or in addition, knowledge 145 can be created at the edge (e.g., by a computer system 140) the through collaboratively collected data from vehicles within the range of the network, such as vehicles 130, 104A-104C. The knowledge creation can include all the vehicles inside of a group, shown in FIG. 1 as vehicles 130, 104A-104C, but might potentially also be extended to surrounding vehicles or a specific region. According to the embodiments, the created knowledge 145 is further associated with metadata.

For example, vehicles 130, 104A-104C can be equipped with on-vehicle sensors that collect real-time data while driving, where the data (e.g., speed, temperature, road conditions, etc.) is pertinent to driving and/or maneuvering operations. This data, also referred to herein as raw sensor data, can then be communicated, stored, analyzed in accordance with various vehicular networking technologies, and analyzed in order to transform the data into knowledge 145. For instance, the speed at which different vehicles move along a road in a certain location can be collected, by the respective vehicles, over time. The raw sensor data can be processed in accordance with the disclosed vehicular knowledge networking capabilities to provide meaningful information in the form of knowledge 145 and the contextual features which constitute its corresponding context 145. Multiple pieces of raw sensor data, possibly from different vehicles 130, 104A-104C infers the inner relationship or repeating patterns and contextual relevance that may be found in data, thereby extracting insight on this data that can serve as knowledge 145 and its context 146. For example, the edge server, namely computer system 140, and the ego vehicle 130 has the capabilities to create contextual features maps for the atypical intersection, and extract meaning contextual information that enables the context analysis system 143 to create context 146 for knowledge 145. In the example of FIG. 1, knowledge 145 can be related to the atypical intersection, or risky zone, for the risk reasoning application. For instance, knowledge 145 can provide insight on the type of maneuvering conflicts (e.g., crossing, merging, sequential and diverging) that are often experienced by vehicles in this atypical intersection. Furthermore, context 146 can provide insight to static properties for the specific location (and its knowledge) including, but not limited to: the location, road geometry, traffic rules, and the like. Context 146 can also provide insight to dynamic properties for the specific location (and its knowledge) including, but not limited to: traffic flow, vehicle/driver type, congestion, type of objects at the location, risk caused by other drivers, etc. Thus, the context 146 provides a contextual relationship inferring the conditions surrounding location at a time when the knowledge 145 was created. Furthermore, the context analysis system 143 is configured to analyze a query for knowledge based on its context, such that only the knowledge having a substantially similar context is forwarded in response to the query.

As referred to herein, a maneuvering conflict is defined as an observable event that may end in an accident unless a safety maneuver is performed (e.g., slows down, changes lanes, or decelerates/accelerates to avoid collision). Thus, the vehicular knowledge networking system 100 forms a knowledge network among entities (e.g., vehicles 130, 104A-104C), where vehicles 130, 104A-104C can deduce and share knowledge 145 for enhanced driver/vehicle safety applications (e.g., risk reasoning) instead of large volumes of raw sensor data and information (which reduces the cost and volume of communication).

In operation, when the driver of the ego vehicle 103 approaches the atypical intersection comprising an offset intersection 175, he or she may not know/remember the standard operating procedures of that intersection (i.e., he or she may not know the rules of the road). Moreover, given the presence of one or more vehicles 104A-104C, the driver may not know/remember which vehicle has the right of way. An atypical intersection can be any intersection that includes roadway features not found in a typical roadway. For purposes of this disclosure “atypical” is defined as an intersection including roadway features that may cause confusion to a driver. For example, as seen in FIG. 1 the roadway includes an offset intersection comprising multiple roadways. The roadway features comprising turn lanes, stop signs, yield signs etc., can be confusing to a driver. Accordingly, the driver of the ego vehicle 130 may want to quantify the risk levels associated with the atypical intersection, and thus sends a request to the edge server (or cloud), specifying a set of knowledge tags (i.e., identification and/or location tags), to receive the knowledge 145 regarding the driving environment.

Additionally, because a key aspect of the disclosed embodiment involves ensuring that knowledge is forwarded having the proper context, queries (or requests) for knowledge are also communicated with contextual data. Restated, a current context describing the current conditions of the driving environment for a vehicle is evaluated when knowledge is requested, to make certain that the knowledge that is retrieved for that driving environment was created within the same context. For instance, in the operational example, the ego vehicle 130 can generate a query for knowledge regarding the atypical intersection, and use its vehicle sensors (e.g., detecting presence of vehicles 104A-104C) to obtain several contextual features associated with the current “context” for the atypical intersection. As a result of sensing presence and/or location of the other vehicles 104A-104C, the ego vehicle 130 can obtain data regarding the traffic flow of the atypical intersection, for example, which is communicated to the computer system 140 as contextual features indicating that the atypical intersection is currently experiencing high traffic, shown in FIG. 1 as a vehicle approaching every entrance to the intersection. These contextual features (associated with the conditions of the atypical intersection) generated at the time the ego vehicle 130 is requesting knowledge for the intersection (e.g., vehicle is approaching the atypical intersection) are analyzed by the context analysis system 143. Accordingly, the context analysis system 143 employs its context-based knowledge forwarding capabilities, as disclosed herein, such that the ego vehicle's 130 query is routed based its context, and the knowledge 145 retrieved specific to the atypical intersection has a corresponding context 146 that matches the context of the query, namely a high traffic condition, is forwarded to vehicle 130. The knowledge 145 that is forwarded to the ego vehicle 130 is selected using a contextual basis, having been created in the substantially same context that the ego vehicle is currently experiencing. In particular, receiving knowledge 145 having a context 146 that is specific to high-traffic conditions suggests that the knowledge will be more beneficial for the vehicle 130 to make an accurate risk analysis and initiate an appropriate safety response that is most applicable to the atypical intersection with high-traffic.

As alluded to above, the knowledge 145 in this example can include risky road users (e.g., abnormal drivers) and identified risky zones. Then, the knowledge 145 can be shared with the ego vehicle 130 through V2C communications. As previously described, the ego vehicle 130 can then execute safety maneuvers as a result of the knowledge 145 it has received regarding the atypical intersection that it is approaching. Furthermore, due to context-based knowledge forwarding, the knowledge 145 has a specific contextual relationship to the atypical intersection such that that the executed safety maneuvers performed based on knowledge 145 are most applicable for the current conditions, or context, of the risk zone. As an example, if the knowledge 145 indicates that atypical intersection is a risky zone, also in a high-traffic context, and/or the nearby vehicles 104A-104C are identified as risky user, certain safety maneuvers may be autonomously performed, such as slowing down, because of the risk and the situational context of the driving environment. The vehicular knowledge networking system 100 and context-based knowledge forwarding techniques realize enhanced safety applications, such as risk reasoning, based on knowledge of a current traffic environment which improves the vehicle/driver safety by making preventive and proactive decisions to minimize the threat for all vehicles that are and/or will be affected by the riskiness. Furthermore, by distributing knowledge (as opposed to large amounts of raw data) and analyzing context for that knowledge using a distinct pre-process (e.g., contextual feature maps are used to prepare the knowledge cycle beforehand) the knowledge networking system 100 may mitigate large delays and overhead which is not tolerable in time-critical responses.

In the example of in FIG. 1, a knowledge cycle can involve the computer system 140 collecting vehicle sensor data from, at least, vehicle 130 and performing knowledge creation from that data. Then, during a knowledge creation stage of the knowledge cycle, an AI/ML modeling approach can be applied to the collected data to create knowledge. Knowledge can be created by a single and/or cluster of vehicles cooperatively or it can be created at the edge through collaboratively collected data from vehicles. The knowledge creation includes all the vehicles inside the cluster but might potentially also be extended to surrounding vehicles or a specific region. The created knowledge is associated with a set of knowledge tags and stored in KB. The knowledge can be placed on edge/cloud server according to mobility of vehicles approaching the risky zone. The system uses Vehicle-to-Cloud communication to network the knowledge. The knowledge is transferred to other locations according to geometry features of road sections. The knowledge is composed with another knowledge based on similarity and used parameter is time of day. The knowledge cycle includes all steps, and the performance is beneficial (i.e., knowledge is delivered to more high number of vehicles.

As used herein, the words “geographic location,” “location,” “geographic position” and “position” refer to a latitude and longitude of an object (or, a latitude, longitude, and elevation of an object), such as a connected vehicle, an RSE, a client device, etc. As used herein, the words “geographic area”, and “area,” refer to a physical space surrounding a geographic location (e.g., an area of defined space surrounding a geographic location or position).

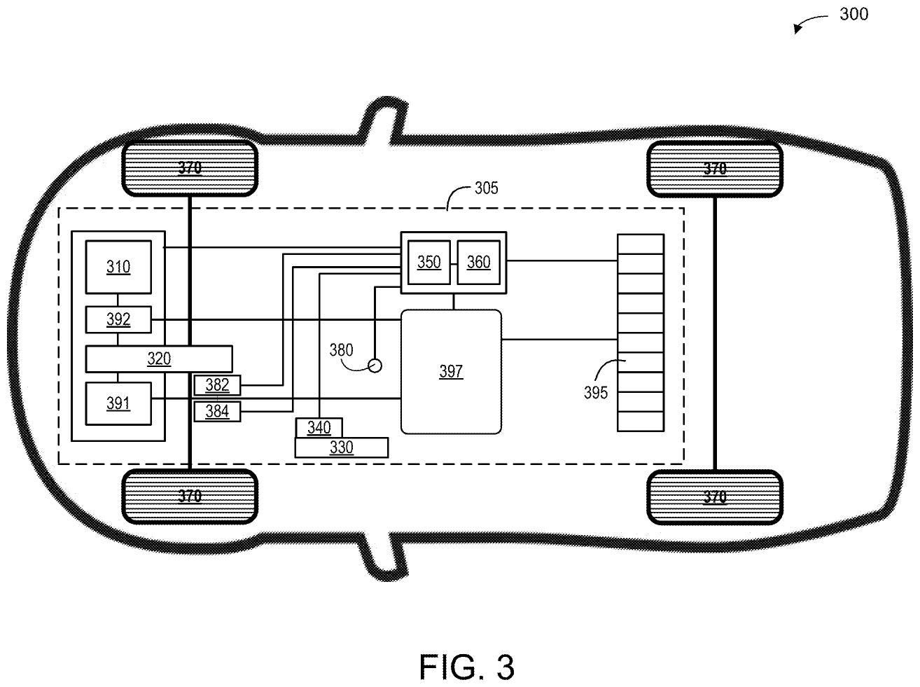

FIG. 3 illustrates an example hybrid electric vehicle (HEV) 300 in which various embodiments for vehicular knowledge networking including improved knowledge cycle are implemented. For example, in one embodiment, the ego vehicle 103 (shown in FIG. 1) is a HEV 300. It should be understood that various embodiments disclosed herein may be applicable to/used in various vehicles (internal combustion engine (ICE) vehicles, fully electric vehicles (EVs), etc.) that are fully or partially autonomously controlled/operated, and not solely HEVs.

Here, HEV 300 includes drive force unit 305 and wheels 370. Drive force unit 305 includes an engine 310, motor generators (MGs) 391 and 392, a battery 395, an inverter 397, a brake pedal 330, a brake pedal sensor 340, a transmission 320, a memory 360, an electronic control unit (ECU) 350, a shifter 380, a speed sensor 382, and an accelerometer 384.

Engine 310 primarily drives the wheels 370. Engine 310 can be an ICE that combusts fuel, such as gasoline, ethanol, diesel, biofuel, or other types of fuels which are suitable for combustion. The torque output by engine 310 is received by the transmission 320. MGs 391 and 392 can also output torque to the transmission 320. Engine 310 and MGs 391 and 392 may be coupled through a planetary gear (not shown in FIG. 3). The transmission 320 delivers an applied torque to the wheels 370. The torque output by engine 310 does not directly translate into the applied torque to the wheels 370.

MGs 391 and 392 can serve as motors which output torque in a drive mode, and can serve as generators to recharge the battery 395 in a regeneration mode. The electric power delivered from or to MGs 391 and 392 passes through inverter 397 to battery 395. Brake pedal sensor 340 can detect pressure applied to brake pedal 330, which may further affect the applied torque to wheels 370. Speed sensor 382 is connected to an output shaft of transmission 320 to detect a speed input which is converted into a vehicle speed by ECU 350. Accelerometer 384 is connected to the body of HEV 300 to detect the actual deceleration of HEV 300, which corresponds to a deceleration torque.

Transmission 320 is a transmission suitable for an HEV. For example, transmission 320 can be an electronically controlled continuously variable transmission (ECVT), which is coupled to engine 310 as well as to MGs 391 and 392. Transmission 320 can deliver torque output from a combination of engine 310 and MGs 391 and 392. The ECU 350 controls the transmission 320, utilizing data stored in memory 360 to determine the applied torque delivered to the wheels 370. For example, ECU 350 may determine that at a certain vehicle speed, engine 310 should provide a fraction of the applied torque to the wheels while MG 391 provides most of the applied torque. ECU 350 and transmission 320 can control an engine speed (NE) of engine 310 independently of the vehicle speed (V).

ECU 350 may include circuitry to control the above aspects of vehicle operation. ECU 350 may include, for example, a microcomputer that includes a one or more processing units (e.g., microprocessors), memory storage (e.g., RAM, ROM, etc.), and I/O devices. ECU 350 may execute instructions stored in memory to control one or more electrical systems or subsystems in the vehicle. ECU 350 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., anti-lock braking system (ABS) or electronic stability control (ESC)), battery management systems, and so on. These various control units can be implemented using two or more separate electronic control units, or using a single electronic control unit.

MGs 391 and 392 each may be a permanent magnet type synchronous motor including for example, a rotor with a permanent magnet embedded therein. MGs 391 and 392 may each be driven by an inverter controlled by a control signal from ECU 350 so as to convert direct current (DC) power from battery 395 to alternating current (AC) power, and supply the AC power to MGs 391, 392. MG 392 may be driven by electric power generated by motor generator MG 391. It should be understood that in embodiments where MG 391 and MG 392 are DC motors, no inverter is required. The inverter, in conjunction with a converter assembly may also accept power from one or more of MGs 391, 392 (e.g., during engine charging), convert this power from AC back to DC, and use this power to charge battery 295 (hence the name, motor generator). ECU 350 may control the inverter, adjust driving current supplied to MG 392, and adjust the current received from MG 391 during regenerative coasting and braking.

Battery 395 may be implemented as one or more batteries or other power storage devices including, for example, lead-acid batteries, lithium ion, and nickel batteries, capacitive storage devices, and so on. Battery 395 may also be charged by one or more of MGs 391, 392, such as, for example, by regenerative braking or by coasting during which one or more of MGs 391, 392 operates as generator. Alternatively (or additionally, battery 395 can be charged by MG 391, for example, when HEV 300 is in idle (not moving/not in drive). Further still, battery 395 may be charged by a battery charger (not shown) that receives energy from engine 310. The battery charger may be switched or otherwise controlled to engage/disengage it with battery 395. For example, an alternator or generator may be coupled directly or indirectly to a drive shaft of engine 310 to generate an electrical current as a result of the operation of engine 310. Still other embodiments contemplate the use of one or more additional motor generators to power the rear wheels of a vehicle (e.g., in vehicles equipped with 4-Wheel Drive), or using two rear motor generators, each powering a rear wheel.

Battery 395 may also be used to power other electrical or electronic systems in the vehicle. Battery 395 can include, for example, one or more batteries, capacitive storage units, or other storage reservoirs suitable for storing electrical energy that can be used to power MG 391 and/or MG 392. When battery 395 is implemented using one or more batteries, the batteries can include, for example, nickel metal hydride batteries, lithium ion batteries, lead acid batteries, nickel cadmium batteries, lithium ion polymer batteries, and other types of batteries.

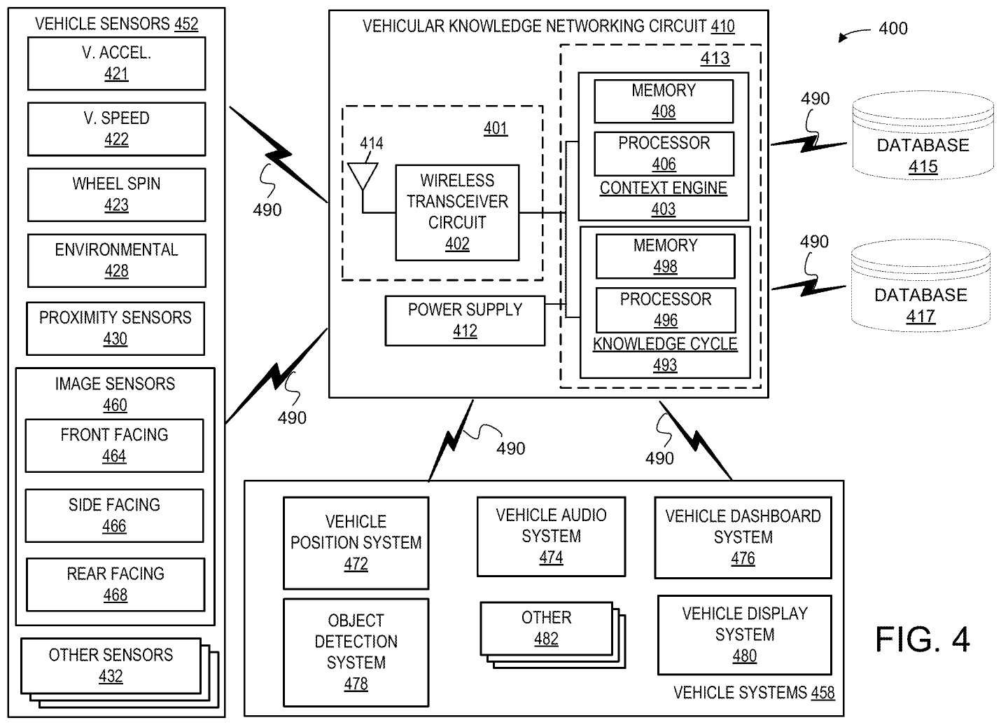

FIG. 4 illustrates an example of a vehicular knowledge networking system 400 in an ego vehicle in accordance with one embodiment of the systems and methods described herein. The vehicular knowledge networking system 400 includes a vehicular knowledge networking circuit 410 communicatively connected to a plurality of sensors 452, a plurality of vehicle systems 458, a database 415 comprising roadway data, and a database 417 comprising right-of-way rules. Sensors 452 and vehicle systems 458 wirelessly communicate with the vehicular knowledge networking circuit 410. Although in this example sensors 452 and vehicle systems 458 are depicted as communicating with vehicular knowledge networking circuit 410, they can also communicate with each other as well as with other vehicle systems. The vehicular knowledge networking circuit 410 can be implemented as an ECU or as part of an ECU. In other embodiments, the vehicular knowledge networking circuit 410 can be implemented independently of the ECU.

The vehicular knowledge networking circuit 410 in this example includes a communication circuit 401, a controller/CPU 413 comprising a context engine 403, and a knowledge cycle engine 493, and a power supply 412. Each engine includes a respective processor 406, 496 and respective memory 408. 396. For example, the context engine 403 includes a processor 406, and a memory 408 configured for performing the context-based knowledge forwarding functions disclosed herein, including but not limited to: analyzing contextual features; constructing contextual feature maps; aggregating contextual features for a specific location and/or region; contextual feature matching; determining a path for knowledge with specific contextual features. The knowledge cycle engine 493 includes a processor 496 and a memory 498 configured for performing knowledge cycle functions with contextual aspects described herein, including but not limited to: executing stages of a knowledge cycle; inferring the contextual feature map of each step of knowledge cycle; and determine a path for knowledge with specific contextual features.

Processor 406 can include one or more GPUs, CPUs, microprocessors, or any other suitable processing system. Processor 406 may include a single core or multicore processors. The memory 408 may include one or more various forms of memory or data storage (e.g., flash, RAM, etc.) that may be used to store instructions and variables for processor 406 as well as any other suitable information, such as, one or more of the following elements: rules data; resource data; GPS data; and base data, as described below. Memory 408 can be made up of one or more modules of one or more different types of memory, and may be configured to store data and other information as well as operational instructions that may be used by the processors 406 and 496.

Although the example of FIG. 4 is illustrated using processor and memory circuitry, as described below with reference to circuits disclosed herein, controller/CPU 413 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up the vehicular knowledge networking circuit 410. Communication circuit 401 includes either or both a wireless transceiver circuit 402 with an associated antenna 414 and a wired I/O interface with an associated hardwired data port (not illustrated). Communication circuit 401 can provide for V2X communications capabilities, allowing the knowledge hub circuit 410 to communicate with edge devices, such as roadside equipment (RSE), network cloud servers and cloud-based databases, and/or other vehicles.

As this example illustrates, communications with the knowledge hub circuit 410 can include either or both wired and wireless communications circuits 401. Wireless transceiver circuit 402 can include a transmitter and a receiver (not shown) to allow wireless communications via any of a number of communication protocols such as, for example, Wi-Fi, Bluetooth, near field communications (NFC), Zigbee, and any of a number of other wireless communication protocols whether standardized, proprietary, open, point-to-point, networked or otherwise. Antenna 414 is coupled to wireless transceiver circuit 402 and is used by wireless transceiver circuit 402 to transmit radio signals wirelessly to wireless equipment with which it is connected and to receive radio signals as well. These RF signals can include information of almost any sort that is sent or received by the vehicular knowledge networking circuit 410 to/from other entities such as sensors 452 and vehicle systems 458.

Power supply 412 can include one or more of a battery or batteries (such as, e.g., Li-ion, Li-Polymer, NiMH, NiCd, NiZn, and NiH2, to name a few, whether rechargeable or primary batteries,), a power connector (e.g., to connect to vehicle supplied power, etc.), an energy harvester (e.g., solar cells, piezoelectric system, etc.), or it can include any other suitable power supply.

In the illustrated example, sensors 452 include vehicle acceleration sensors 421, vehicle speed sensors 422, wheelspin sensors 423 (e.g., one for each wheel), environmental sensors 428 (e.g., to detect salinity or other environmental conditions), proximity sensor 430 (e.g., sonar, radar, lidar or other vehicle proximity sensors), and image sensors 460. Additional sensors (i.e., other sensors 432) can be included as may be appropriate for a given implementation of vehicular knowledge networking system 400.

The sensors 452 include front facing image sensors 464, side facing image sensors 466, and/or rear facing image sensors 468. Image sensors may capture information which may be used in detecting not only vehicle conditions but also detecting conditions external to the ego vehicle 103 as well. Image sensors that might be used to detect external conditions can include, for example, cameras or other image sensors configured to capture data in the form of sequential image frames forming a video in the visible spectrum, near infra-red (IR) spectrum, IR spectrum, ultraviolet spectrum, etc. Image sensors 460 can be used to, for example, to detect objects in an environment surrounding ego vehicle 103, for example, traffic signs indicating a current speed limit, road curvature, obstacles, surrounding vehicles, and so on. For example, one or more image sensors 460 may capture images of neighboring vehicles in the surrounding environment. As another example, object detecting and recognition techniques may be used to detect objects and environmental conditions, such as, but not limited to, road conditions, surrounding vehicle behavior (e.g., driving behavior and the like), parking availability, etc. Additionally, sensors may estimate proximity between vehicles. For instance, the image sensors 460 may include cameras that may be used with and/or integrated with other proximity sensors 430 such as LIDAR sensors or any other sensors capable of capturing a distance. As used herein, a sensor set of a vehicle may refer to sensors 452 and image sensors 460 as a set.

Vehicle systems 458 include any of a number of different vehicle components or subsystems used to control or monitor various aspects of the vehicle and its performance. In this example, the vehicle systems 458 includes a vehicle positioning system 472; vehicle audio system 474 comprising one or more speakers configured to deliver audio throughout the vehicle; object detection system 478 to perform image processing such as object recognition and detection on images from image sensors 460, proximity estimation, for example, from image sensors 460 and/or proximity sensors, etc. for use in other vehicle systems; suspension system 480 such as, for example, an adjustable-height air suspension system, or an adjustable-damping suspension system; and other vehicle systems 482 (e.g., (e.g., Advanced Driver-Assistance Systems (ADAS), such as forward/rear collision detection and warning systems, pedestrian detection systems, autonomous or semi-autonomous driving systems, and the like).

The vehicle positioning system 472 includes a global positioning system (GPS). Ego vehicle 103 and the one or more connected vehicles 104 may be DSRC-equipped vehicles. A DSRC-equipped vehicle is a vehicle which: (1) includes a DSRC radio; (2) includes a DSRC-compliant Global Positioning System (GPS) unit; and (3) is operable to lawfully send and receive DSRC messages in a jurisdiction where the DSRC-equipped vehicle is located. A DSRC radio is hardware that includes a DSRC receiver and a DSRC transmitter. The DSRC radio is operable to wirelessly send and receive DSRC messages.

A DSRC-compliant GPS unit is operable to provide positional information for a vehicle (or some other DSRC-equipped device that includes the DSRC-compliant GPS unit) that has lane-level accuracy. In some embodiments, a DSRC-compliant GPS unit is operable to identify, monitor and track its two-dimensional position within 1.5 meters of its actual position 68% of the time under an open sky.

Conventional GPS communication includes a GPS satellite in communication with a vehicle comprising a GPS tracking device. The GPS tracking device emits/receives a signal to/from the GPS satellite. For example, a GPS tracking device is installed into a vehicle. The GPS tracking device receives position data from the GPS tracking device. The position data gathered from the vehicle is stored in the tracking device. The position data is transmitted to the cloud server via a wireless network.

A conventional GPS provides positional information that describes a position of a vehicle with an accuracy of plus or minus 10 meters of the actual position of the conventional GPS unit. By comparison, a DSRC-compliant GPS unit provides GPS data that describes a position of the DSRC-compliant GPS unit with an accuracy of plus or minus 1.5 meters of the actual position of the DSRC-compliant GPS unit. This degree of accuracy is referred to as “lane-level accuracy” since, for example, a lane of a roadway is generally about 3 meters wide, and an accuracy of plus or minus 1.5 meters is sufficient to identify which lane a vehicle is traveling in on a roadway. Some safety or autonomous driving applications provided by an Advanced Driver Assistance System (ADAS) of a modern vehicle require positioning information that describes the location of the vehicle with lane-level accuracy. In addition, the current standard for DSRC requires that the location of the vehicle be described with lane-level accuracy.

As used herein, the words “geographic location,” “location,” “geographic position” and “position” refer to a latitude and longitude of an object (or, a latitude, longitude, and elevation of an object), such as a connected vehicle, an RSE, a client device, etc. As used herein, the words “geographic area”, and “area,” refer to a physical space surrounding a location (e.g., an area of defined space surrounding a geographic location or geographic position). The example embodiments described herein may provide positioning information that describes a geographic position of a vehicle with an accuracy of one or more of: (1) at least plus or minus 1.5 meters in relation to the actual geographic position of the vehicle in two dimensions including a latitude and a longitude; and (2) at least plus or minus 3 meters in relation to the actual geographic position of the vehicle in an elevation dimension. Accordingly, the example embodiments described herein are able to describe the geographic position of the vehicle with lane-level accuracy or better.

Network 490 may be a conventional type of network, wired or wireless, and may have numerous different configurations including a star configuration, token ring configuration, or other configurations. Furthermore, the network 490 may include a local area network (LAN), a wide area network (WAN) (e.g., the Internet), or other interconnected data paths across which multiple devices and/or entities may communicate. In some embodiments, the network may include a peer-to-peer network. The network may also be coupled to or may include portions of a telecommunications network for sending data in a variety of different communication protocols. In some embodiments, the network 490 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communication, mmWave, Wi-Fi (infrastructure mode), Wi-Fi (ad-hoc mode), visible light communication, TV white space communication and satellite communication. The network may also include a mobile data network that may include 3G, 4G, 5G, LTE, LTE-V2V, LTE-V2I, LTE-V2X, LTE-D2D, VOLTE, 5G-V2X or any other mobile data network or combination of mobile data networks. Further, the network 390 may include one or more IEEE 802.11 wireless networks.

In one embodiment, data comprising the location of vehicle is captured by the vehicle position system 458. The vehicle position system 458 can include one or more sensors 452 configured to capture vehicle position data. The vehicle positioning system 472 communicates with the vehicular knowledge networking circuit 410 to communicate and utilize knowledge at the ego vehicle 103 for various driving and/or maneuvering functions, including autonomous or semi-autonomous vehicle/driver safety features (e.g., related to risk reasoning).

In an embodiment, the vehicular knowledge networking system 400 produces notifications for the driver of the ego vehicle 130 using one or more notification methods. For example, the driver may receive a visual and/or audible notification that they are approaching an identified risky zone, based on knowledge the vehicular knowledge networking circuit 410 has received in accordance with knowledge networking capabilities, as disclosed herein. In one embodiment, the notification methods include the vehicle systems 458 comprising the vehicle audio system 472 and the vehicle dashboard system 476. The notification methods includes visual and/or audible methods of informing the driver of safety related issues. In one embodiment, the notification methods include notifying the driver of the ego vehicle 103 via one or more vehicle systems 458. For example, in one embodiment, the driver is notified of riskiness of a driving environment via the vehicle audio system 474 (e.g., instructions played/broadcasted over one or more vehicle speakers), the vehicle display system 480 and/or the vehicle dashboard system 476. In one embodiment, the driver is notified of safety issues by a navigation system within the instrument cluster and the dashboard GUI. The notification can include visual instructions (e.g., visual directions on how to proceed), and/or auditory instructions (e.g., verbal commands from the vehicular knowledge networking system 400 to the driver).

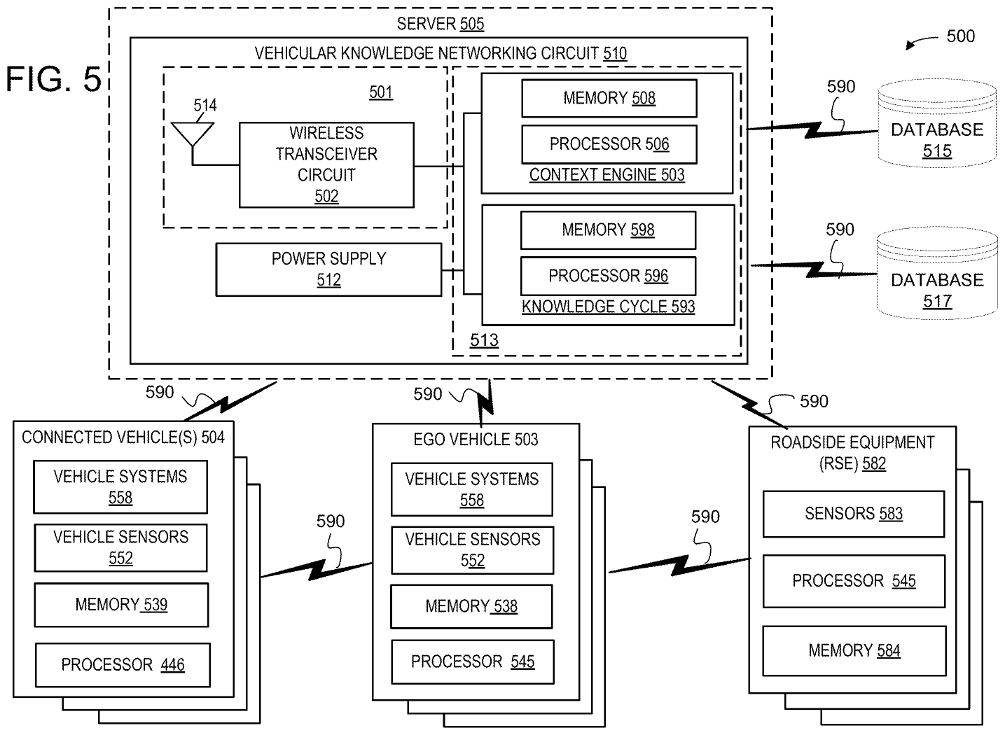

FIG. 5 is an example a vehicular knowledge networking system 500 implemented in an entity external and/or remote to the ego vehicle 130 (shown in FIG. 1). In this example, a vehicular knowledge networking circuit 510 implementing the disclosed vehicular knowledge networking and context-based knowledge forwarding capabilities is included in server 505, shown as a cloud/edge server. According, the system 500 utilizes a V2X network architecture in accordance with various embodiments disclosed herein. The network architecture includes the cloud server 505 comprising the vehicular knowledge networking circuit 510, a connected vehicle 504 (e.g., vehicles 104A-104C), the ego vehicle 503 and a roadside equipment (RSE) 582 infrastructure component of a roadway. RSE 582 includes sensors 583, a processor 545 and memory 584. The sensors 583, processor 545 and memory 584 can include sensors same as/similar to vehicle sensors 552, processor 506, processor 596, memory 508 or memory 598. The cloud server 505, connected vehicle 504 and ego vehicle 503 and RSE 582 can all communicate with one another. For example, connected vehicle 504 can communicate with the ego vehicle 503, and the ego vehicle 103 can communicate with the RSE 582. In some embodiments, connected vehicle 504 includes a communication circuitry comprising hardware and software that is needed to enable the connected vehicle 504 to communicate with the ego vehicle 503, RSE 582 and/or cloud server 505 via network 590. The ego vehicle is also a “connected vehicle”, but for explanation purposes is referred to as the “ego vehicle”. In one embodiment, the connected vehicle 504 includes the same or similar vehicle systems and sensors as the ego vehicle. Using one or more sensors and/or vehicle systems, the connected vehicle 504 can collaborate on the task of providing a precise location of the ego vehicle 503 by leveraging their respective sensor sets (e.g., sensors 452, systems 458, and/or image sensors 460 of FIG. 4).

In one embodiment, knowledge at the cloud server 505 (e.g., knowledge created and stored via vehicular knowledge networking circuit 510) requested by the ego vehicle 503 can be transmitted from cloud server 505 to the one or more connected vehicle 504 using V2X communication methods. In one embodiment, the V2I communication method includes ego vehicle 503 communication to the cloud server 505 via RSE 582. The vehicle's position can be determined using the RSE 582. The RSE 582 is in communication with the cloud server 505. For example, RSE can receive data comprising the location of the ego vehicle 503, and communicate the data to cloud server 505 via network 390. Inversely, the cloud server 505 can communicate with either directly with the ego vehicle via a C2V communication method or to the RSE, which can subsequently relay the data, including knowledge, from the cloud server 505 to the ego vehicle 503. In one embodiment, the V2V communication method includes ego vehicle 503 communication with one or more connected vehicles 504A-504C. The one or more connected vehicles 504A-504C can communicate with the ego vehicle 503. In one embodiment, the one or more connected vehicles 504A-504C may relay knowledge from the cloud server 505 to the ego vehicle 503. In one embodiment, the one or more connected vehicles 504A-504C relay data from the ego vehicle 503 to the cloud server 505. In addition, when the one or more connected vehicles 504A-504C are within a proximity to other vehicles, they can create a local network and exchange data with the ego vehicle 503 forming a “hub” in a vehicular knowledge network.

As used herein, “connected vehicle” refers to a vehicle that is actively connected to edge devices, other vehicles, and/or a cloud server via a network through V2X communication comprising V2I, V2C, C2V and/or V2V communications. An “unconnected vehicle” refers to a vehicle that is not actively connected. That is, for example, an unconnected vehicle may include communication circuitry capable of wireless communication (e.g., V2X, V2I, V2V, etc.), but for whatever reason is not actively connected to other vehicles and/or communication devices. For example, the capabilities may be disabled, unresponsive due to low signal quality, etc. Further, an unconnected vehicle, in some embodiments, may be incapable of such communication, for example, in a case where the vehicle does not have the hardware/software providing such capabilities installed therein.

The V2X network is a communication network that enables entities such as elements of the operating environment to wirelessly communicate with one another via one or more of the following: Wi-Fi; cellular communication including 3G, 4G, LTE, 5G, etc.; Dedicated Short Range Communication (DSRC); millimeter wave communication; etc. The V2X includes V2I, V2C, C2V and/or V2V communications.

For example, connected vehicle 504 and ego vehicle 503 may have V2X communication capabilities, allowing vehicle 504 to communicate with RSE 582. For example, RSE 582 may be a vehicle-to-infrastructure (V2I)-enabled street light or camera. Connected vehicle 504 and ego vehicle 503 may also communicate with other connected vehicle 404 over vehicle-to-vehicle (V2V) communications.

In one embodiment, data, such as knowledge, is received by the ego vehicle 503 from one or more connected vehicles 504 and/or RSE 582 via one or more V2X communication methods (e.g., V2I communication with RSE 482, V2C/C2V communication with the cloud server 505, and/or V2V communication with one or more connected vehicles 504. For example, in one embodiment knowledge regarding a shared driving environment, for example when all of the vehicles 503, 504 are traveling along the same roadway, can be transmitted from the one or more connected vehicles 504 to the ego vehicle 503. Furthermore, in one embodiment, knowledge can be transmitted from ego vehicle 503 to the cloud server 505 directly via V2C or C2V communication methods or via the RSE 582 as a relay to the cloud via V2I communication methods.

It should be understood that sometimes, a vehicle itself may act as a network node or edge computing device. For example, connected vehicle 504 may be a network edge device. The data gathered by the connected vehicle 504, either through their own sensors, or other data sources, e.g., RSE 582 and other vehicles, may be ultimately be transmitted to the cloud, e.g., the cloud server 505 and cloud-based memory 508 via network 590.

Cloud server 505 may be an edge server or a cloud server. The cloud server 505 can communicate with RSE 582, connected vehicle 504 and/or ego vehicle 503. The cloud server 505 may be one or more cloud-based instance of processor-based computing device residents communicatively connected to database 515, database 517, RSE 582, ego vehicle 503 and/or connected vehicle 504. The cloud server 505 may include circuitry to control various aspects of the vehicular knowledge networking system 500 described herein. Cloud server 505 may include, for example, a microcomputer that includes a one or more processing units (e.g., microprocessors), memory storage (e.g., RAM, ROM, etc.), and I/O devices. As seen in FIG. 5, the cloud server 505 includes a context engine 593 comprising a memory 598 and a processor 596. The processor 596 is configured to execute instructions stored in memory 598. The instruction stored in memory 598 include instructions related to context-based knowledge forwarding functions, as disclosed herein. The cloud server 505 further includes a knowledge cycle engine 513 comprising a memory 508 and a processor 506. The processor 506 is configured to execute instructions stored in memory 508. The instructions stored in memory 508 include instructions to execute the knowledge cycle functions with contextual aspects, as disclosed herein.

The connected vehicle(s) 504 include vehicle systems 558, vehicle sensors 552, memory 539 and processor 546. The vehicle systems 558, vehicle sensors 552, memory 539 and processor 546 include the same and/or similar capabilities as the vehicle systems 558, vehicle sensors 552, memory 538 and processor 545 described herein. In embodiments where in the connected vehicle(s) include the ego vehicle 503 (i.e., the ego vehicle 503 is a “connected vehicle” that communicates with other connected vehicles 504, RSE 582 and/or cloud server 505 via one or more V2X methods of communication), the vehicles systems 558, vehicle sensors 552, memory 539 and processor 546 include vehicle systems 558, vehicle sensors 552, memory 538 and processor 545.

Referring now to FIG. 6, an example of a process 600 that implements aspects of context-based knowledge forwarding, as disclosed herein, is depicted. In an example, the process 600 can be performed by a processor, CPU, or computer system that is executing functions of vehicular knowledge networking. In an embodiment, a processor and/or controller of a vehicle computer is implementing the process 600. As alluded to above, the knowledge cycle includes several stages, or steps, that are executed therein. Thus, in an example, a full knowledge cycle includes steps (e.g., five steps) starting from the beginning of the cycle at knowledge creation, proceeding to knowledge storage, knowledge networking, and so on, and returning back again to knowledge creation. Thus, the knowledge cycle can be thought of as an iterative process, that continues through the cycle of steps where the knowledge stays alive, being stored, updated and forwarded to the various entities in the vehicular knowledge network. In some instances, a knowledge cycle may be partial and includes a smaller subset (e.g., two steps-four steps) of the aforementioned steps (e.g., not requiring each of the aforementioned five steps to be executed). An example of a partial knowledge cycle is a cycle that begins with knowledge creation, and continues only to knowledge networking (e.g., not performing composition).

The knowledge cycle generally relates to the creation and consumption of knowledge within the vehicular knowledge network. Furthermore, a key concept of the disclosed embodiments involves ascertaining contextual relevance for knowledge, for example where the context provides insight into the conditions at a specific location at the time the knowledge was created. This context associated with the knowledge cycle can be analyzed and ultimately used to derive at least one path (e.g., a particular arrangement of stages of the knowledge cycle) within the knowledge cycle for knowledge having a particular context that maximizes the knowledge's benefits (also referred to herein as “beneficial” stages of a knowledge cycle). In other words, the process 600 of FIG. 6 creates knowledge and corresponding context, in a manner that enables a context-based analysis where the contextual information is leveraged to later retrieve knowledge having the right context for its application. Moreover, the process 600 particularly constructs context while the knowledge is being created (e.g., during the knowledge cycle), namely prior to receiving a transfer request for the knowledge after it has been created. By creating context and creating knowledge concurrently, as opposed to during knowledge transfer, the process 600 avoids additional delay and maximizes benefits of the knowledge cycle, and further realizes several advantages over any conventional vehicular knowledge networking systems that may also consider context.

In FIG. 6, the process 600 begins at operation 602 where one or more contextual feature maps are constructed. Contextual feature maps are constructed from contextual features, where the contextual features are often times raw data (e.g., from vehicle sensors) and the contextual features maps is the contextual insight that can be inferred from analyzing this data. Contextual features can be used to define a degree of similarity in data, information, and knowledge. That is, knowledge that may be deemed to have similar contexts are characterized by sharing many of the same contextual features. In some embodiments, the data for contextual features are obtained by several connected vehicles, for instance utilizing their on-vehicle sensors. As an example, the contextual features for a specific location are sensed by the one or more connected vehicles within the vicinity and subsequently are communicated from these vehicles to a cloud/edge server for further analysis. Accordingly, operation 602 can involve receiving contextual features, or the data, from several entities in the vehicular knowledge network. Contextual features can include various static properties that give contextual insight for a specific location, examples including but not limited to: location, road geometry, traffic rules, and the like. Contextual features can also include various dynamic properties that give contextual insight for the specific location, examples including but not limited to: traffic flow, vehicle/driver type, congestion, type of objects at the location, risk caused by other drivers, weather conditions, and the like. After contextual features for a specific location are obtained, then contextual feature maps for that location are constructed from the contextual features.

The contextual feature maps may be considered as “context” or insight that is extract from a plurality of collected data, namely the contextual features. In each level of the hierarchal architecture of data (shown in FIG. 2), a different granularity degree of data is sensed, such that insight is extracted from each level in a manner that granularly builds a contextual relationship to the data. As a result of analyzing each of these levels (e.g., data, information, and knowledge) various sets of contextual features can be inferred to gain a “context” that is ultimately linked to the knowledge (vis-à-vis constructing contextual feature maps). Restated, after operation 602, an instance of knowledge (for a specific location) will have corresponding contextual feature maps that tie the knowledge to a form of contextual insight for the particular location. In an embodiment, the contextual feature maps are stored with the knowledge to which it corresponds.

In some cases, operation 602 can be executed at the entities themselves, and as a result, fully constructed contextual feature maps are collected from the different entities and then aggregated. For instance, a plurality of connected vehicles in the same location/region can each analyze contextual features and construct their individual contextual feature map for the location. Thereafter, each of the vehicles can communicate their individual contextual feature maps to an edge/cloud server, where the server can then construct an aggregation of received contextual feature maps that correspond to the particular location/region. Accordingly, contextual feature map can be constructed in operation 602 by one or more entities in the vehicular knowledge network, including vehicles and/or servers.

As previously described, a significant aspect of the process 600 involves generating the knowledge's context while the knowledge itself is being created. The contextual feature maps are constructed in operation 602 in parallel with a knowledge cycle, which includes knowledge creation. Thus, operation 602 forms this contextual relationship before the knowledge is eventually used (e.g., requested by an entity) in the future. Additionally, in an embodiment, the contextual feature maps are further leveraged to even prepare the knowledge cycle beforehand. By executing operation 602 and linking context to the knowledge beforehand, the process 600 mitigates additional delays and overhead later, particularly at the critical time when the knowledge is actually needed at the vehicle. In some cases, operation 602 includes communicating the contextual feature maps to other entities within the vehicular knowledge network, such as several other cloud/edge servers, after the maps have been constructed.

Subsequently, at operation 604, a query for knowledge is filtered based on context. That is, sometime after the contextual features maps are constructed and stored, an entity of the vehicular knowledge network may request the knowledge for use, such as risky zone analysis of a driving location. In order to support context-based retrieval, a knowledge query is communicated from the entity based on contextual features that the entity is currently sensing. For example, at the time a knowledge query is submitted, a vehicle can leverage its capabilities to obtain several contextual features (e.g., vehicle sensors) of the current location, thereby creating some type of contextual insight into the current conditions of that specific location. Restated, a knowledge query (or request) is submitted with a corresponding context. Operation 604 is executed in response to receiving a knowledge query and its context, namely contextual features, from an entity. Thus, knowledge is created having context, and a query for such knowledge also has context. Operation 604 leverages this context for the knowledge query and performs a context-focused routing of the query, in order to retrieve knowledge in a manner that is more efficient and accurate. Since knowledge is requested based on the current contextual frame of the location at that time, and context has also been tied to the knowledge that has been previously created, a determination of whether the knowledge query is contextual similar to stored knowledge can be used to filter the query and retrieve the appropriate knowledge. As previously described, determining that knowledge has contextual similarities suggests that the insight was created for a location with substantially the same conditions, and thus the knowledge may be more beneficial.

Operation 604 includes performing a context-based analysis, in order to determine which route(s) for the knowledge query have the greatest likelihood of ultimately retrieving stored knowledge that has the same context as the knowledge query. In an embodiment, the context-based analysis involves examining the contextual features that are submitted with the knowledge query, and then determining the storage location for the knowledge that has the greatest amount of shared contextual features. For example, if it is determined that two instances of knowledge share substantially the same contextual features in their respective contexts, this can be considered as a longest contextual feature match. As an example of longest contextual feature matching, each feature in a first set of contextual features (corresponding to a first instance of knowledge) can be compared against each feature of a second set of contextual features (corresponding to another instance of knowledge), and if the number of features that match each other are greater than a determined threshold (e.g., indicating a majority), then the knowledge can be considered to have a longest contextual feature match (e.g., having a substantially similar context). The longest contextual feature matching technique can be utilized as a form of context-based analysis to determine the “best” knowledge to retrieve based on context, and subsequently the knowledge query is routed to the destination, such as an edge/cloud server, where that contextually appropriate knowledge is located. In some embodiments, other forms of data analysis mechanisms that would be suitable for determining a degree of contextual similarity based on features, such as deep learning (e.g., machine learning), may be used in combination with (or in lieu of) longest contextual feature matching in order to implement the context-based routing of operation 604. Furthermore, operation 604 can include filtering the knowledge query, such that the query is prevented from being communicated to other locations where knowledge that is not contextual similar resides. For example, if knowledge fails a longest contextual matching comparison with the knowledge query, indicating that the knowledge does not have enough contextual similarities (e.g., knowledge is not the right context), then the location for that knowledge is filtered out from the destinations for the query.

Thereafter, the knowledge query is routed to the destination location(s) where knowledge that is deemed contextually suitable (e.g., based on the performed context analysis) resides. For instance, if knowledge that is stored on a remote edge/cloud server is determined to be the longest contextual feature match for the knowledge query, then an edge/cloud server that may be local to the requesting vehicle (e.g., initially receiving the knowledge query) will route the query to that remote server.

Subsequently, in operation 606, the stored knowledge, particularly knowledge that is contextually relevant to the query, is retrieved from its storage location and forwarded to the requesting entity within the vehicular knowledge network. In some cases, the knowledge is retrieved and communicated from a remote edge/cloud server where the knowledge has been stored and forwarded to a vehicle requesting the knowledge using V2C technology. For instance, knowledge is retrieved in operation 606 in response to receiving the query routed to the determined destination location, based on the context-centric routing performed in previous operation 604. By leveraging context-based analysis, the knowledge that is retrieved in operation 606 is known to have a context (e.g., contextual feature maps) that is substantially similar to the context associated with the knowledge query, which suggests that the retrieved knowledge will be particularly beneficial to the specific conditions of the requesting entity's location. Thus, the context-based knowledge forwarding of process 600 accomplishes retrieving the right knowledge in the right context, without delay and overhead.

Referring to FIG. 7, an example vehicular knowledge network 700 implementing the disclosed context-based knowledge forwarding features is depicted. In the example of FIG. 1, a first driving environment is shown as a round-a-bout, where a vehicular knowledge networking hub 710 is formed. The vehicular knowledge networking hub 710 is illustrated to include a plurality of connected vehicles 711, and an edge/cloud server 712 that are all co-located in the same physical vicinity. The connected vehicles 711 can utilize sensor measurements, for instance obtained by their on-vehicle sensors, to construct contextual features 713 (e.g., including static/dynamic data) that provide a contextual relevance that is specific to the location, such as the situational conditions that are currently being experienced at the round-a-bout. As previously described, the contextual features can be created alongside of knowledge creation for the specific location, for instance including contextual features and/or contextual map construction as part of a knowledge cycle. The contextual features generated by the connected vehicles 711, can be communicated to the hub's 710 local edge/cloud server 712. Thereafter, the edge/cloud server 712 can leverage the connected vehicles 711 to construct contextual feature map(s) 713 that specific to the location, namely the round-a-bout. The contextual feature map(s) 713 that are specific to the local round-a-bout, which can be considered as the “context” of the location, can then be communicated from the hub 710 (vis-à-vis the edge/cloud server 711) to other remote vehicular knowledge networking entities/hubs, which is illustrated in FIG. 7 as other edge/cloud servers 705 and 722. In some embodiments, the contextual feature map(s) 713 for location are communicated throughout the vehicular knowledge network with the knowledge to which it corresponds. Thus, the link between knowledge for the location, and the context of the location (while the knowledge is created) is maintained. This example serves to illustrate that the bulk of context-based analysis, which involves generating a contextual relationship to knowledge, is performed prior to the knowledge being utilized or even requested (e.g., knowledge query), which allows the disclosed embodiments to leverage context to improve knowledge without incurring additional delays and overhead.

At a later time, for instance when knowledge of risk is needed at a location having a similar round-a-bout driving environment, a vehicle 721 may submit a knowledge query. Vehicle 721 is depicted as an entity at another vehicular knowledge networking hub 720 that is remotely location from the previously described hub 710 where the knowledge was created. In some cases, the vehicle 721 may initially submit its knowledge query to an entity that is local to its own hub 720, such as connected remote server 722. FIG. 1 illustrates that “context” is also constructed for the second round-a-bout location, shown as contextual feature maps 723. Therefore, the embodiments can leverage “context” for both the driving environments where knowledge is created and where knowledge is requested (and will be ultimately applied). The vehicle 721 may send both the knowledge query and the corresponding constructed contextual feature maps 722 to its local edge/cloud server 721. Then, the edge/cloud server 721 leverages the contextual features map 722 to perform context-based routing (e.g., including longest contextual feature map), as described herein. In the example, the edge/cloud servers 721, 705, and 712 are configured to implement the disclosed context-based routing and context-based knowledge forwarding techniques disclosed herein. As an example of context-based routing, FIG. 1 depicts that the edge/cloud server 721 deems the knowledge stored at edge/cloud server 705 as being too contextually dissimilar from the knowledge query. For instance, it can be determined that the knowledge at edge/cloud server 705 has contextual feature maps 706 that are substantially dissimilar than the contextual feature map 723 for the query, and thus fail a longest contextual feature matching comparison. Because the knowledge at edge/cloud server 705 is known to have the wrong context (using context-based analysis), the edge/cloud server 722 then filters that edge/cloud server 705 from being a destination to route the knowledge query submitted by vehicle 721.

Alternatively, FIG. 7 depicts that the edge/cloud server 721 deems the knowledge stored at edge/cloud server 712 has an appropriate context for the vehicle's 721 knowledge query. For example, the disclosed context analysis techniques can be utilized to determine that the contextual feature map 713 is contextually similar to the contextual feature map 723 corresponding to the knowledge query. FIG. 7 illustrates that the contextual feature map 713 has many of the same contextual features (shown in FIG. 7 as individual squares) that are also contained in the contextual feature map 723, and thus the context of the knowledge at edge/cloud server 712 has a successful longest contextual feature match when compared to the context of the knowledge request. Because the knowledge at edge/cloud server 712 is known to have the right context (using context-based analysis), the edge/cloud server 722 allows the knowledge query submitted by vehicle 721 to be routed to the edge/cloud server 712. The knowledge at edge/cloud server 712 which is in the proper context, is retrieved and ultimately forwarded to the vehicle 721. Consequently, context-based knowledge ensures that the right knowledge in the right context is sent to the vehicle 721, where the knowledge shares a meaningful contextual relationship to the location such that the knowledge is more beneficial and/or accurate for the vehicle's 721 risk analysis, particularly at the second round-a-bout. Furthermore, the context-based knowledge system and methods can improve the benefits of knowledge in an efficient manner that improves the performance of applications that utilize the knowledge, for instance enhancing vehicle/driver safety features.

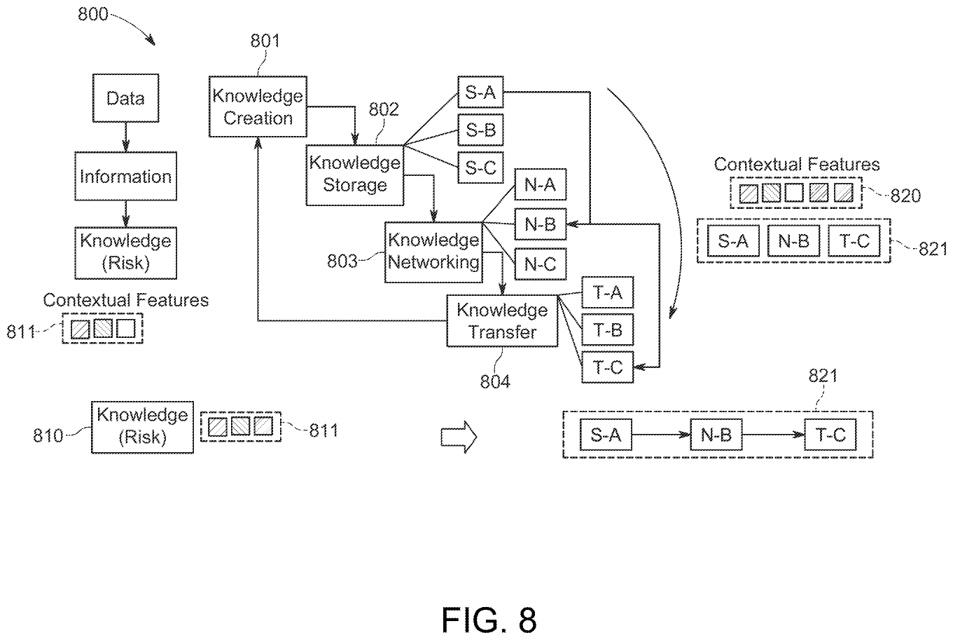

FIG. 8 depicts another application for contextual based analysis of knowledge, as disclosed herein. In particular, FIG. 8 illustrates a conceptual diagram of a process for predicting a path for a knowledge cycle that is based on context analysis. As a general description, context associated with knowledge can be analyzed and ultimately used to derive at least one path (e.g., a particular arrangement of stages of the knowledge cycle) within the knowledge cycle that is known to have a high performance (also referred to herein as “beneficial” stages of a knowledge cycle). FIG. 8 illustrates how conducting a context-based analysis for multiple knowledge cycles over time can be leveraged to identify at least one path that has a high occurrence rate for knowledge having a certain context, and further predicting that this same path may be beneficial for future knowledge having a substantially similar context. In other words, the example of FIG. 8 shows linking a particular path (for a knowledge cycle) to a specific context of knowledge, and then using a context-based prediction to determine whether the path is optimal for future knowledge based on this correlation.

As described previously, context corresponding to knowledge is created in order to provide a form of contextual relevance to knowledge. The knowledge cycle can be described as the overall steps for creating and/or distributing knowledge in vehicular knowledge networking, and a knowledge cycle can be executed having several stages. Furthermore, an improved knowledge cycle process is implemented that involves creating associated metadata in each stage of the knowledge cycle. The metadata associated with the knowledge cycle can be analyzed and ultimately used to derive at least one path (e.g., a particular arrangement of stages of the knowledge cycle) within the knowledge cycle that is known to be a “beneficial” knowledge cycle. Details regarding metadata for a knowledge cycle are described in related application “SYSTEMS AND METHODS TO IMPROVE KNOWLEDGE CYCLES IN VEHICULAR KNOWLEDGE NETWORKING” U.S. patent application Ser. No. 18/173,524 which is incorporated herein in its entirety. This metadata is directly associated with the knowledge cycle and provides context to each stage, thusly the metadata can be analyzed such that a repetitive pattern is inferred. The inference is indicative of at least one path (or a particular arrangement of stages) in the knowledge cycle that is beneficial. A beneficial path can be described as a composite of specific stages of a knowledge cycle that are most utilized. For instance, if the majority of vehicles in a vehicular network frequently use knowledge that has been created from a model-based approach (e.g., “model-based” is metadata describing the type of knowledge creation used in that stage of the knowledge cycle), then it can be inferred that knowledge created using the model-based approach has wide-spread benefits (e.g., accurate, highly applicable, high performance, context rich, etc.). Additionally, by analyzing this metadata, it can be determined that the specific “model-based knowledge creation stage” would be a part of the beneficial path for that knowledge cycle. As illustrated in FIG. 8, a beneficial path 821 (determined by analyzing the metadata and context) of the knowledge cycle 800 can be determined for knowledge that is identified to have a particular context, which allows the cycle to be adaptively modified for optimal performance. That is, a beneficial path is determined for a particular context, and subsequently when other instances of knowledge are identified to be within that same context, the knowledge cycle for that contextually similar knowledge can be prepared prior to executing the knowledge cycle and modified to include the beneficial path to improve the cycle's performance, and ultimately maximize the benefits of knowledge.

An example of a knowledge cycle 800 is shown in FIG. 8, where the knowledge cycle 800 comprises several stages that includes: knowledge creation 801; knowledge storage 802; knowledge networking 803; and knowledge transfer 804. The knowledge storage 802 stage has associated metadata “S-A”, “S-B”, and “S-C” providing information regarding which mechanism for knowledge storage is employed during an iteration of a knowledge cycle. Further, the knowledge networking 803 stage has associated metadata “N-A”, “N-B”, and “N-C” providing information regarding which method of knowledge networking is employed during an iteration of a knowledge cycle. Lastly, the knowledge transfer 804 stage has associated metadata “T-A”, “T-B”, and “T-C” providing information regarding which mechanism of knowledge transfer is employed during an iteration of a knowledge cycle.

Also, FIG. 8 depicts multiple contextual features for knowledge 810 being created in order to provide “context” for the knowledge. For example, several contextual features (e.g., generated by a plurality of vehicles) can be obtained that are associated with a specific location, where the features are compiled to generate a contextual feature map 811 that infers a context surrounding the knowledge, shown in FIG. 8 as risk knowledge 810, which corresponds to that location. The contextual feature map 811 for the knowledge 810 may be created concurrently with the knowledge 810 itself, so as to eliminate any additional overhead and/or delays when the knowledge is actually needed (e.g., knowledge forwarded to entities of the vehicular knowledge network). In other words, the contextual feature map 811 that corresponds to the instance of knowledge 810 is created during its knowledge cycle 800 (e.g., creating the knowledge).

A key aspect of the disclosed process is identifying a context for knowledge during its knowledge cycle, which enables a context-based analysis of the knowledge cycle (using its metadata) to be leveraged to determine at least one path that has a high rate of occurrence (e.g., most used) for knowledge with a particular context. In the example of FIG. 8, particularly instances of knowledge having the contextual feature map 820 are identified, and the corresponding knowledge cycles for knowledge in this context is analyzed over several iterations in order to specify which stages are frequently occurring. For instance, this process can be performed for knowledge and knowledge cycles in the past, prior to creating knowledge 810. Analyzing metadata for the knowledge cycle 800 can be implemented as a machine learning (ML) process that infers trends in the knowledge cycle to identify which knowledge cycles are beneficial, and further to extract which stages of the beneficial knowledge cycles have a high rate of occurrence signifying that those stages are key to its high performance. Thus, the context-based analysis of the knowledge cycle 800 and corresponding metadata can be leveraged to determine that knowledge having the contextual feature map 820 is linked to a particular “beneficial” or frequently occurring knowledge cycle path 821. This beneficial path 821, indicates that it may be most optimal for knowledge having a contextual feature map 820 to utilize a knowledge cycle arrangement that includes the knowledge storage stage of “S-A”, a knowledge networking stage of “N-B” and a knowledge transfer stage “T-C”. Furthermore, a context-based prediction can be employed to predict whether it is optimal to utilize the same beneficial path 821 for other instances of knowledge that are identified to be within the contextual realm of the context feature map 820.

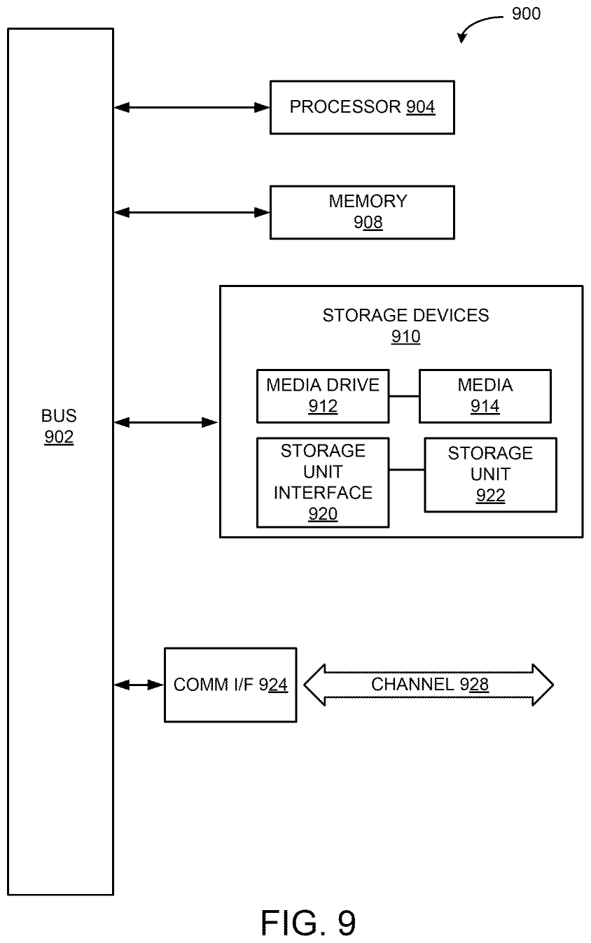

Thereafter, the context of knowledge 810 can be identified as being contextually similar to the knowledge that is linked to the beneficial path 821. For example, FIG. 8 shows that the contextual feature map 811 of the risk knowledge 810 contains a number of the same context features that are within the contextual feature map 820, which directly corresponds to the beneficial path 821. Thus, by positively identifying a degree of contextually similarity, the context-based prediction process predicts that the beneficial path 821 would be optimal for executing the knowledge cycle of knowledge 810. Accordingly, the knowledge cycle 800 for knowledge 810 can be dynamically modifying and/or adjusting prior to actually executing the cycle, which allows the knowledge cycle to integrate the beneficial path 821 that has been identified as optimal for knowledge in this context. For example, executing the knowledge cycle 800 for knowledge 811 may only involve the stages that are included in the beneficial path 821 in the current iteration (and any subsequent iterations) of the knowledge cycle 800. In other words, by dynamically adjusting knowledge cycles to execute only the deemed “beneficial” stages from the path 821, the knowledge cycle is optimized even prior to executing the cycle. Other methods to optimize/adjust a knowledge cycle, can be utilized to ultimately to ensure that the most beneficial mechanisms (e.g., beneficial path) for performing each cycle, and in turn, improving the performance of the knowledge cycle in a manner that achieves a context-based optimization.

Where components are implemented in whole or in part using software, these software elements can be implemented to operate with a computing or processing component capable of carrying out the functionality described with respect thereto. One such example computing component is shown in FIG. 9. Various embodiments are described in terms of this example computing component 900 After reading this description, it will become apparent to a person skilled in the relevant art how to implement the application using other computing components or architectures.

Referring now to FIG. 9, computing component 900 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 900 might also represent computing capabilities embedded within or otherwise available to a given device. For example, a computing component might be found in other electronic devices such as, for example, portable computing devices, and other electronic devices that might include some form of processing capability.

Computing component 900 might include, for example, one or more processors, controllers, control components, or other processing devices. Processor 904 might be implemented using a general-purpose or special-purpose processing engine such as, for example, a microprocessor, controller, or other control logic. Processor 904 may be connected to a bus 902. However, any communication medium can be used to facilitate interaction with other components of computing component 900 or to communicate externally.

Computing component 900 might also include one or more memory components, simply referred to herein as main memory 908. For example, random access memory (RAM) or other dynamic memory, might be used for storing information and instructions to be executed by processor 904. Main memory 908 might also be used for storing temporary variables or other intermediate information during execution of instructions to be executed by processor 904. Computing component 900 might likewise include a read only memory (“ROM”) or other static storage device coupled to bus 902 for storing static information and instructions for processor 904.

The computing component 900 might also include one or more various forms of information storage mechanism 910, which might include, for example, a media drive 912 and a storage unit interface 920. The media drive 912 might include a drive or other mechanism to support fixed or removable storage media 914. For example, a hard disk drive, a solid-state drive, a magnetic tape drive, an optical drive, a compact disc (CD) or digital video disc (DVD) drive (R or RW), or other removable or fixed media drive might be provided. Storage media 914 might include, for example, a hard disk, an integrated circuit assembly, magnetic tape, cartridge, optical disk, a CD or DVD. Storage media 914 may be any other fixed or removable medium that is read by, written to or accessed by media drive 912. As these examples illustrate, the storage media 914 can include a computer usable storage medium having stored therein computer software or data.

In alternative embodiments, information storage mechanism 910 might include other similar instrumentalities for allowing computer programs or other instructions or data to be loaded into computing component 900. Such instrumentalities might include, for example, a fixed or removable storage unit 922 and the storage unit interface 920. Examples of such storage units 922 and storage unit interfaces 920 can include a program cartridge and cartridge interface, a removable memory (for example, a flash memory or other removable memory component) and memory slot. Other examples may include a PCMCIA slot and card, and other fixed or removable storage units 922 and storage unit interfaces 920 that allow software and data to be transferred from storage unit 922 to computing component 900.

Computing component 900 might also include a communications interface 924. Communications interface 924 might be used to allow software and data to be transferred between computing component 900 and external devices. Examples of communications interface 924 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 924 may be carried on signals, which can be electronic, electromagnetic (which includes optical) or other signals capable of being exchanged by a given communications interface 924. These signals might be provided to communications interface 924 via a channel 928. Channel 928 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 908, storage unit interface 920, media 914, and channel 928. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 900 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system, comprising:
a computer system constructing a knowledge context corresponding to knowledge, wherein the knowledge context and the knowledge are associated with a first driving environment during creation of the knowledge, and performing context-based knowledge forwarding for a knowledge query by determining that the knowledge context corresponds to a query context of a knowledge query; and
a vehicle communicatively connected to the computer system, the vehicle comprising:
a processor device generating a query context corresponding to a knowledge query, wherein the query context is associated with a second driving environment during querying for the knowledge, and submitting the knowledge query with the query context; and
a controller device receiving the knowledge, in response to the knowledge query, and performing one or more safety operations approaching the second driving environment, wherein the received knowledge is routed to the vehicle using the context-based knowledge forwarding and the received knowledge has a knowledge context that corresponds to the query context of the second driving environment.

2. The system of claim 1, wherein the computer system receives the knowledge context as knowledge contextual feature maps constructed by a plurality of connected vehicles at the first driving environment.

3. The system of claim 2, wherein the knowledge contextual feature maps comprise static features and dynamic features relating to the first driving environment.

4. The system of 3, wherein the computer system receives the query context as query contextual feature maps constructed by the vehicle at the second driving environment.

5. The system of claim 4, wherein the computer system performs context-based knowledge forwarding using a context-based analysis function.

6. The system of claim 5, wherein the computer system performs the context-based analysis function comprising longest contextual feature matching.

7. The system of claim 6, wherein the computer performs longest contextual feature matching by determining whether a selected number of contextual features in the knowledge contextual feature maps match the contextual features in the query contextual feature maps.

8. The system of claim 7, wherein the computer performs context-based knowledge forwarding by, in response to determining that the knowledge context and the query context fail the longest contextual feature matching, filtering the knowledge query such that the knowledge is not forwarded to the vehicle.

9. The system of claim 6, wherein the computer performs context-based knowledge forwarding by, in response to determining that the knowledge context and the query context pass the longest contextual feature matching, routing the knowledge query such that the knowledge is forwarded to the vehicle.

10. The system of claim 1, wherein the vehicle further comprises circuity communicatively connected to a vehicular knowledge network.

11. The system of claim 10, wherein the vehicular knowledge network comprises one or more entities communicating knowledge within the vehicular knowledge network.

12. The system of claim 11, wherein the one or more entities comprise the computer system, and the vehicle receives the communicated knowledge forwarded from the computer system via the vehicular knowledge network.

13. The system of claim 12, wherein the circuity receives knowledge forwarded from the computer system vehicles via vehicle-to-cloud (V2C) communication.

14. The system of claim 1, wherein the knowledge is associated with risk reasoning of the second driving environment.

15. The system of claim 14, wherein the one or more safety operations comprises autonomous safety maneuvers based on the risk reasoning of the second driving environment.

16. A system comprising:
at least one memory storing machine-executable instructions; and
at least one processor configured to access the at least one memory and execute the machine-executable instructions to:
construct knowledge contextual feature maps corresponding to knowledge, wherein the knowledge contextual feature maps and the knowledge are associated with a first driving environment during creating the knowledge;
receive a knowledge query with query contextual feature maps corresponding to the query, wherein the query contextual feature maps and the knowledge query are associated with a second driving environment during querying the knowledge;
perform a context-based routing for the knowledge query based on performing a context analysis function on the knowledge feature maps and the query feature maps; and
retrieve and forward the knowledge in response to determining a contextual relationship between the knowledge feature maps and the query feature maps based on the performed context analysis function, wherein the knowledge is forwarded via a vehicular knowledge network.

17. The system of claim 16, wherein the at least one processor configured to access the at least one memory further executes the machine-executable instructions to:
perform a knowledge cycle creating the knowledge and concurrently constructing the knowledge contextual feature maps corresponding to the knowledge;
perform a context analysis function using longest contextual feature matching;
and determine that there is a contextual relationship between the query contextual features and the knowledge contextual features in response to determining a longest contextual feature match in a comparison of one or more features of the query contextual feature map and one or more contextual features of the knowledge contextual feature map; and
determine that there is no contextual relationship between the query contextual features and the knowledge contextual features in response to determining no contextual feature match in a comparison of one or more contextual features of the query contextual feature map and one or more contextual features of the knowledge contextual feature map.

18. The system of claim 17, wherein the at least one processor configured to access the at least one memory further executes the machine-executable instructions to:
perform a context-based routing for the knowledge query by forwarding the knowledge request to a destination location for the knowledge associated with the knowledge contextual feature maps, in response to the determination that there is a contextual relationship between the query contextual features and the knowledge contextual features.

19. The system of claim 17, wherein the at least one processor configured to access the at least one memory further executes the machine-executable instructions to:
perform a context-based routing for the knowledge query by filtering the destination location for the knowledge associated with the knowledge contextual feature maps such that the knowledge query is not forwarded to the destination location and the knowledge is not retrieved and forwarded, in response to the determination that there is no contextual relationship between the query contextual features and the knowledge contextual features.

20. A method comprising:
constructing, by at least one processor, knowledge contextual feature maps corresponding to knowledge, wherein the knowledge contextual feature maps and the knowledge are associated with a first driving environment during creating the knowledge;
receiving, by at least one processor, a knowledge query with query contextual feature maps corresponding to the query, wherein the query contextual feature maps and the knowledge query are associated with a second driving environment during querying the knowledge;
performing, by at least one processor, a context-based routing for the knowledge query based on performing a context analysis function on the knowledge feature maps and the query feature maps; and
retrieving and forwarding, by at least one processor, the knowledge in response to determining a contextual relationship between the knowledge feature maps and the query feature maps based on the performed context analysis function, wherein the knowledge is forwarded via a vehicular knowledge network.
